(19) United States
(12) Patent Application Publication
(10) Pub. No.: US 2021/0329499 A1
(43) Pub. Date: Oct. 21, 2021

(54) ENHANCED QUALITY OF SERVICE FOR 5G WIRELESS COMMUNICATIONS

(71) Applicants: Necati Canpolat, Beaverton, OR (US); Binita Gupta, San Diego, CA (US); Vivek Gupta, San Jose, CA (US)

(72) Inventors: Necati Canpolat, Beaverton, OR (US); Binita Gupta, San Diego, CA (US); Vivek Gupta, San Jose, CA (US)

(21) Appl. No.: 17/357,727

(22) Filed: Jun. 24, 2021

Related U.S. Application Data
(60) Provisional application No. 63/057,207, filed on Jul. 27, 2020.
(60) Provisional application No. 63/057,202, filed on Jul. 27, 2020.
(60) Provisional application No. 63/043,632, filed on Jun. 24, 2020.

(51) Int. Cl. H04W 28/24; H04W 76/10; H04W 28/02; H04W 12/108

(52) U.S. Cl. CPC H04W 28/24; H04W 76/10; H04W 84/12; H04W 12/108; H04W 28/0268

(57) ABSTRACT

This disclosure describes systems, methods, and devices related to quality-of-service (QoS) for fifth generation (5G) wireless communications. A device may identify a frame received from a second device, the frame indicative of fifth-generation (5G) quality-of-service (QoS) characteristics; determine an Internet Protocol Security (IPSec) Security Parameter Index (SPI) field, the IPSec SPI field; generate, using a wireless local area network station (WLAN STA) of the device, a request frame, the request frame including a requested 802.11 User Priority, and comprising an IPSec information element, the IPSec information element including an IPSec Security Protocol field indicative of an encapsulated security protocol, the IPSec information element further including the IPSec SPI field and a destination Internet Protocol (IP) address; send the request frame to an access point; and identify a response frame received, from the access point device, the response frame indicative of an admission or rejection of the requested 802.11 User Priority.

### CROSS-REFERENCE TO RELATED APPLICATION(S)

This application is related to and claims priority to U.S. Provisional Patent Application No. 63/043,632, filed Jun. 24, 2020, to U.S. Provisional Patent Application No. 63/057,202, filed Jul. 27, 2020, and to U.S. Provisional Patent Application No. 63/057,207, filed Jul. 27, 2020, which are hereby incorporated herein by reference in their entirety.

### TECHNICAL FIELD

This disclosure generally relates to systems, methods, and devices for wireless communications and, more particularly, for quality-of-service (QoS) for fifth generation (5G) wireless communications.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 illustrates a network, in accordance with one or more example embodiments of the present disclosure.

FIG. 2 illustrates an example end-to-end quality of service (QoS) model for Wi-Fi communications in fifth-generation (5G) systems, in accordance with one or more example embodiments of the present disclosure.

FIG. 3A illustrates an example QoS management process for 5G user data flows using wireless local area network (WLAN) access, in accordance with one or more example embodiments of the present disclosure.

FIG. 3B illustrates an example QoS management process for 5G user data flows using WLAN access, in accordance with one or more example embodiments of the present disclosure.

FIG. 4A illustrates an example QoS management process for 5G user data flows using WLAN access, in accordance with one or more example embodiments of the present disclosure.

FIG. 4B illustrates an example QoS management process for 5G user data flows using WLAN access, in accordance with one or more example embodiments of the present disclosure.

FIG. 5 illustrates an example WLAN reference architecture for network-centric QoS management for 5G process flows or signaling, in accordance with one or more example embodiments of the present disclosure.

FIG. 6A illustrates an example WLAN station (STA)-initiated QoS negotiation for 5G traffic using 802.11 QoS management frames, in accordance with one or more example embodiments of the present disclosure.

FIG. 6B illustrates an example WLAN STA-initiated QoS negotiation for 5G traffic using 802.11 QoS management messages, in accordance with one or more example embodiments of the present disclosure.

FIG. 7A illustrates an example WLAN access point (AP)-initiated QoS negotiation for 5G traffic using 802.11 QoS management frames, in accordance with one or more example embodiments of the present disclosure.

FIG. 7B illustrates an example WLAN AP-initiated QoS negotiation for 5G traffic using 802.11 QoS management messages, in accordance with one or more example embodiments of the present disclosure.

FIG. 8 illustrates a flow diagram of illustrative process for QoS using 5G communications, in accordance with one or more example embodiments of the present disclosure.

FIG. 9 illustrates a functional diagram of an exemplary communication station that may be suitable for use as a user device, in accordance with one or more example embodiments of the present disclosure.

FIG. 10 illustrates a block diagram of an example machine upon which any of one or more techniques (e.g., methods) may be performed, in accordance with one or more example embodiments of the present disclosure.

FIG. 11 is a block diagram of a radio architecture in accordance with some examples.

FIG. 12 illustrates an example front-end module circuitry for use in the radio architecture of FIG. 11, in accordance with one or more example embodiments of the present disclosure.

FIG. 13 illustrates an example radio IC circuitry for use in the radio architecture of FIG. 11, in accordance with one or more example embodiments of the present disclosure.

FIG. 14 illustrates an example baseband processing circuitry for use in the radio architecture of FIG. 11, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 family of standards provides the technology for Wi-Fi communications. The Third-Generation Partnership Project (3GPP) releases 15 and 16 define support for integrating untrusted and trusted Wi-Fi access networks with fifth generation (5G) systems through N3IWF (Non-3GPP Inter-Working Function) and TNGF (Trusted Non-3GPP Gateway Function) functions respectively as described in TS 23.501 of the technical standards. A user equipment (UE) can establish a protocol data unit (PDU) session over Wi-Fi access only, or it can establish Multi-Access PDU session (MA PDU session) which enables carrying user plane traffic over both 3GPP (NR, LTE) and Wi-Fi access simultaneously. These PDU sessions carry user data traffic over 5G QoS flows. A 5G quality of service (QoS) flow is the finest granularity for QoS differentiation within the 5G system. For 5G QoS flows which are to be carried over WLAN access (either for single access PDU session or MA PDU session), the N3IWF/TNGF receives 5G QoS profile information with a QoS Flow Identifier (QFI), QoS characteristics and parameters from the 5G Core Network.

In 5G systems, the QoS requirements of these 5G QoS flows are also applicable when these flows are carried over WLAN access. In WLAN, QoS differentiation over the WLAN link is provided by 802.1e defined QoS enhancements which specifies mapping of 802.11 User Priorities (UP) to 4 QoS Access Categories for background, best effort, video and voice traffic (AC_BK, AC_BE, AC_VI, AC_VO) [2]. It is important to ensure that the QoS differentiation within WLAN access can be provided for these 5G QoS flows carried over Wi-Fi access taking into account 5G QoS characteristics, to satisfy end-to-end QoS requirements for applications/services no matter which radio access carries the traffic.

The 3GPP specification for 5G enables gateway functions N3IWF & TNGF and UE to set differentiated services code point (DSCP) markings for Internet Protocol (IP) packets exchanged over wireless local area network (WLAN) networks integrated in 5G systems. These in-band DSCP markings are used within the WLAN network to map DSCP to IEEE 802.11 User Priority and Wi-Fi multimedia (WMM) Access Category to provide QoS differentiation for DSCP-marked IP packets. However, this approach may not work with untrusted WLAN integration where the path between N3IWF and WLAN access point (AP) is likely unmanaged/traverses the internet, and where in-band DSCP markings may get reset by routers over that path. This will result in no QoS differentiation for the 5G flows sent over untrusted WLAN access. Also, the current 3GPP solution does not support QoS differentiation for 5G NAS signaling sent over the WLAN access, as no DSCP marking is provided for the signaling traffic sent over WLAN. Enabling QoS differentiation for NAS signaling over WLAN can provide QoS benefits to meet requirements for different services and applications. For example, 5G non-access-stratum (NAS) signaling data can be prioritized with AC_VO or AC_VI on the Wi-Fi access, resulting in reduced control plane latency for 5G signaling over Wi-Fi, which can be useful for low-latency applications. The in-band DSCP marking for QoS differentiation does not provide any detailed 5G QoS characteristics and parameters to a WLAN AP that can be beneficial for WLAN AP to perform resource allocation/reservation for 5G flows within the WLAN access.

In IP networks, traffic classification and differentiated service treatment is achieved through DiffServ, which makes use of a 6-bit DSCP (Differentiated Services Code Point) field in the IP header to mark packets for traffic classification and packet forwarding behavior at the routers. As described above, in 5G systems, the gateway functions N3IWF & TNGF and the UE supports setting DSCP markings in IP header for packets transmitted over WLAN access. The WLAN AP then maps the received DSCP values to 802.11 UP & WMM Access Categories to provide QoS differentiation over WLAN for the inbound/DL packets.

In the current 3GPP 5G architecture, the mapping between 5G QoS to Wi-Fi QoS can be achieved in an implementation specific way by configuring mapping between 5G QoS to DSCP markings at the gateway functions N3IWF and TNGF. However, the 3GPP specifications do not provide any standardized way for mapping 5G QoS (5QI values) to DSCP markings, though global system for mobile communications (GSMA) IR.34 provides limited mapping between 3GPP QCI 1-9 and DSCP values.

The current 3GPP 5G solution with in-band DSCP marking to provide QoS differentiation over WLAN access has a number of limitations, which may be addressed by embodiments of the present disclosure, including: (1) The in-band DSCP marking based approach may not work for untrusted Wi-Fi integration where the path between N3IWF and WLAN AP is unmanaged and likely traverses the internet and in-band DSCP markings may get reset by the routers over that path, resulting in no QoS differentiation for the 5G flows in the WLAN access. (2) It does not support QoS differentiation for 5G NAS signaling sent over WLAN access, as no DSCP marking is provided for the signaling data sent over WLAN. QoS differentiation for NAS signaling over WLAN can provide QoS benefit to meet requirements for different services and applications e.g. reduced control plane latency for low latency services and applications. (3) It does not provide detailed 5G QoS characteristics to WLAN AP. The WLAN AP can use 5G QoS info for resource allocation/reservation within the WLAN access for the 5G flows.

The mapping between 5G QoS to DSCP markings at the gateway functions (N3IWF and TNGF) is implementation dependent, and there is no recommendation provided by 3GPP to map 5G QoS characteristics to Wi-Fi QoS. This could result in inconsistent QoS experience across different 5G network deployments.

In the current 3GPP solution, a WLAN access network does not have any knowledge of 5G QoS information for 5G flows to be carried over Wi-Fi access. With the 5G QoS information, the QoS negotiation and QoS traffic stream establishment can be performed within WLAN access for IPsec SAs carrying 5G traffic, taking into account 5G QoS characteristics and parameters.

In a 5G system, the gateway functions N3IWF & TNGF and the UE support setting DSCP markings in IP header for packets transmitted over WLAN access. The WLAN AP and station device (STA) can then map the received DSCP values to IEEE 802.11 User Priority and Access Category to provide QoS differentiation over WLAN for the DL and UL packets. However, the 3GPP specifications do not provide any standardized way for mapping 5G QoS (5QI values) to DSCP markings, and the mapping is left to the implementation.

For trusted WLAN access integrated with 5G, the 3GPP specification provides QoS information to the UE for 5G flows to be carried over the IPsec SA established over WLAN access. However, how this QoS information can be used within WLAN access to provide QoS differentiation for IPsec SAs carrying 5G traffic is left to the implementation.

The current 3GPP 5G solution with in-band DSCP marking to provide QoS differentiation over WLAN access has following limitations: (1) The in-band DSCP marking based approach may not work for Wi-Fi integration where the path between N3IWF/TNGF and WLAN AP is unmanaged and might traverse the internet (e.g. for untrusted WLAN integration) and the in-band DSCP markings may get reset by the routers over that path, resulting in no QoS differentiation for the 5G flows in the WLAN access. (2) The mapping between 5G QoS (5QI) to DSCP markings at the gateway functions (N3IWF and TNGF) is implementation dependent and there is no recommendation provided by 3GPP to map 5G QoS characteristics to Wi-Fi QoS. This could result in inconsistent QoS experience across different 5G network deployments. (3) Current DSCP based solution does not provide detailed 5G QoS flow characteristics, parameters and flow identification/filtering information to WLAN STA on the device. The WLAN STA can use 5G QoS related information to trigger QoS negotiation and resource reservation for 5G flows within the WLAN domain.

There is therefore a need for enhanced QoS for 5G wireless communications.

Example embodiments of the present disclosure relate to systems, methods, and devices for enhanced QoS for 5G wireless communications.

In one or more embodiments, the present disclosure describes a WLAN AP-initiated (network centric) QoS negotiation mechanism within the WLAN access to establish QoS traffic streams and provide QoS differentiation for 5G user data flows and 5G signaling carried over trusted Wi-Fi access, to ensure end-to-end Quality of Service over Wi-Fi in 5G systems.

In one or more embodiments, to support QoS differentiation for 5G flows over a trusted WLAN access, the present disclosure provides a network-centric QoS management scheme within WLAN to negotiate QoS prioritization and setup QoS traffic streams for 5G traffic carried over IPsec tunnels. We propose enhancements to existing 802.11 QoS management frames/elements to achieve the network initiated QoS negotiation for 5G flows within WLAN.

Some vendors and operators may deploy 5G systems possibly with integrated Wi-Fi access for applications in enterprises, homes, industrial automation and public hotspots. In one or more embodiments, the present disclosure enables QoS negotiation and QoS traffic stream setup for 5G traffic (5G user data and 5G signaling) carried over IP Security (IPsec) tunnels established over Wi-Fi access in 5G systems. This can ensure end-to-end Quality of Service for 5G services/applications carried over Wi-Fi access, enabling seamless usage of 3GPP and Wi-Fi radios, thus providing improved user experience for 5G services.

In one or more embodiments, the proposed QoS differentiation mechanism in this disclosure may be included as part of future IEEE 802.11 or WFA specifications.

In one or more embodiments, the present disclosure may provide WLAN Reference Architecture for Network-Centric QoS Management for 5G Traffic. A higher layer entity called ‘5G QoS Entity’ may be co-located within a WLAN AP to provide support for network centric QoS management for 5G traffic. The 5G QoS Entity receives 5G QoS related information from the TNGF for 5G user data flows and 5G signaling. The 5G QoS related information includes 5G QoS flow characteristics and parameters, IPsec SA (security association) info to identify IPsec child SAs and IPsec signaling SA established over WLAN to carry 5G traffic, any assigned DSCP value for IPsec SA, associated 5G PDU Session ID and the UE IP Address for the Wi-Fi interface.

In one or more embodiments, the IPsec SA info includes information to identify IPsec security associations in each direction for UL and DL traffic. For each IPsec SA (uplink SA and downlink SA) the SPI (Security Parameter Index), the destination IP address and security protocol ID information is provided.

In one or more embodiments, the 5G QoS Entity on the WLAN AP initiates QoS negotiation with the SME after it receives 5G QoS related information from the TNGF. The 5G QoS Entity maps the 5G QoS flow characteristics and parameters to 802.11 QoS Traffic Specification (TSPEC) and 802.11 User Priority. The DSCP value received can be taken into account to determine mapping of 5G QoS to 802.11 User Priority. The TSPEC can specify desired QoS parameters for traffic streams (TS) in both UL and DL direction if same QoS parameters apply in both directions, or separate TSPEC can be generated to specify QoS parameters for traffic streams in UL and DL direction.

In one or more embodiments, the 5G QoS Entity also creates two separate 802.11 Traffic Classification (TCLAS) elements, one each for UL and DL traffic, from the IPsec SA information received from the TNGF to indicate traffic filters for the IPsec SAs carrying 5G traffic. This entity also maps the UE Wi-Fi IP address to WLAN STA MAC Address. The 5G QoS Entity sets the Higher Layer Stream ID for the AP-initiated TS setup to 3GPP PDU Session ID received from the TNGF.

In one or more embodiments, the 5G QoS Entity on WLAN AP provides the following information to the SME for QoS negotiation for 5G traffic: (1) 802.11 QoS Traffic Specification (TSPEC). (2) 802.11 Traffic Classification (TCLAS) elements indicating traffic filters for the IPsec SAs in UL and DL carrying 5G traffic. (3) User Priority for IPsec SAs in UL and DL, provided as part of TCLAS element. (4) 5G_TSPEC element with detailed 5G QoS flow characteristics and parameters. (4) Higher Layer Stream ID, set to PDU Session ID for 5G. (4) WLAN STA medium access control (MAC) Address of the UE.

In one or more embodiments, after receiving QoS negotiation trigger from the 5G QoS Entity, the station management entity (SME) on a WLAN AP triggers QoS negotiation and traffic stream (TS) setup for IPsec SAs both in the UL and DL direction using the AP-initiated TS Setup procedure described in the IEEE 802.11 specification with enhancements as captured below. The network centric QoS management model is also applicable for Wi-Fi only devices with 3GPP NAS functionality for connecting to 5G Core over trusted WLAN access. The 3GPP stack on such devices refers to 3GPP NAS+NWt interface functionality as defined in the 3GPP specifications.

In one or more embodiments, the present disclosure provides QoS Negotiation and Traffic Stream setup within WLAN for IPsec SAs carrying 5G Traffic. There are two options for network centric QoS negotiation and to establish QoS traffic streams (TS) for carrying 5G traffic over IPsec SAs within WLAN access. Option 1: QoS negotiation with enhancements to 802.11 QoS management frames. Option 2: QoS negotiation with new QoS management messages. Regarding Option 1, an AP initiated QoS negotiation procedure for 5G traffic (5G user data flows or 5G signaling) may be used to setup QoS traffic streams (TS) with enhancements to existing 802.11 QoS management frames. The 5G QoS Entity triggers the AP-initiated TS Setup procedure by sending a QoS TS Setup Request to the SME on the WLAN AP. This message includes one or more TSPEC elements (with QoS parameters for UL and DL TS), TCLAS elements (for identifying IPSec SAs carrying 5G traffic and associated 802.11 User Priority), 5G_TSPEC element (providing 5G QoS flow characteristics and parameters), Higher Layer Stream ID (HLStreamID, set to PDU Session ID for 5G) and UE WLAN STA MAC Address. Two separate TCLAS elements are included to provide filtering information for identifying IPsec SAs carrying 5G traffic in UL and DL. After receiving the QoS TS Setup Request, the SME initiates an MLME-ADDTS Reserve Request primitive with the MAC layer with parameters as shown below, populated based on parameters received from the 5G QoS entity. This primitive includes 3 new parameters PeerSTAAddress, TCLAS element and 5G_TSPEC element as highlighted below, besides the parameters specified in 802.11-2016. More than one TSPEC element can be included to specify different set of QoS parameters for traffic streams in UL and DL direction. The process may use the following:

```
MLME-ADDTSRESERVE.request (
  TSPEC,
  HigherLayerStreamID,
  Schedule,
  VendorSpecificInfo,
  PeerSTAAddress,
  TCLAS,
  5G_TSPEC
  )
```

In one or more embodiments, the MAC layer initiates QoS TS setup by sending an ADDTS Reserve Request (as an Action frame) to the non-AP STA specified by the PeerSTAAddress in the MLME-ADDTS Reserve Request. The ADDTS Reserve Request sent to the non-AP STA includes two new parameters TCLAS and 5G_TSPEC as highlighted below in Table 1, besides the parameters specified in the IEEE 802.11 specification at Table 9-356.

TABLE 1
Mapping 5G QoS Parameters to TSPEC Parameters

| TSPEC Parameter | |
|---|---|
| (for Admission Control) | Mapped 5G QoS Parameter |
| Minimum Data Rate | GBR flow: Guaranteed Flow Bit Rate (GFBR) |
| | Non-GBR flow: not specified |
| Mean Data Rate | GBR flow: Guaranteed Flow Bit Rate (GFBR) |
| | Non-GBR flow: Session Aggregate Maximum Bit |
| | Rate (Session-AMBR) Note 1 |
| Peak Data Rate | GBR flow: Maximum Flow Bit Rate (MFBR) |
| | Non-GBR flow: Session Aggregate Maximum Bit |
| | Rate (Session-AMBR) Note 1 |
| Burst Size (Optional) | Max Data Burst Volume |

Note 1:
For Non-GBR flow, Session Aggregate Maximum Bit Rate indicate aggregate bit rate for all the non-
GBR flows for a PDU session. This Session-AMBR can be mapped to Mean Data Rate and Peak Data Rate in
the TSPEC only when all the flows of a PDU session are mapped to the same IPsec child SA.

In one or more embodiments, after receiving the ADDTS Reserve Request, the non-AP STA generates the MLME-ADDTS Reserve Indication primitive, which notifies the SME of the receipt of the ADDTS Reserve Request from the AP. The SME starts the QoS Traffic Stream (TS) negotiation procedure with the AP for the TSPEC QoS parameters and TCLAS traffic filters received in the MLME-ADDTS Reserve Indication primitive. The QoS negotiation is done by exchanging ADDTS Request/Response with the AP to setup the UL and DL traffic streams as per TSPEC parameters. Multiple ADDTS Request/Response exchange happens with the AP to setup QoS TS in both UL and DL direction. The ADDTS Request message includes the TSPEC element as received in the ADDTS Reserve Request and the TCLAS element specifying traffic filters and User Priority for the corresponding IPsec SA (UL or DL SA). The TCLAS element might not be included for IPsec SA carrying UL traffic, in which case the User Priority is included as part of the TSPEC element.

In one or more embodiments, the ADDTS Request also echoes the 5G_TSPEC element received from the AP, which provides detailed 5G QoS flow characteristics and parameters which can be used by the AP for resource allocation/reservation for 5G flows. The Higher Layer Stream ID for 5G (which is set to PDU Session ID) is included in each of the ADDTS Request/Response exchange. The ADDTS Response frame includes set of parameters as defined in the 802.11 specification.

In one or more embodiments, if the QoS negotiation and TS setup is successful for both UL and DL IPsec SAs indicated by success status code in the ADDTS Response frame, the non-AP STA sends an ADDTS Reserve Response frame to the AP with the Higher Layer Stream ID for 5G and indicating success status code for the QoS negotiation. If the TS setup fails, the non-AP STA sends an ADDTS Reserve Response frame to the AP with the Higher Layer Stream ID for 5G and indicating a failure status code for the QoS negotiation. The SME on the AP sends a QoS TS Setup Response message to the 5G QoS Entity indicating the success/failure outcome of QoS negotiation for the IPsec SAs carrying 5G traffic.

In one or more embodiments, Option 2 may include QoS negotiation with new QoS management messages. Tables 2 and 3 below shows AP initiated QoS negotiation procedure for 5G traffic to setup QoS traffic streams (TS) with new set of QoS management messages defined. In this option, new set of QoS Reservation Request/Response messages are defined to trigger AP-initiated QoS negotiation for IPsec SAs carrying 5G traffic. The QoS Reservation Request carries same set of QoS related parameters as the ADDTS Reserve Request frame described above, which includes TSPEC, TCLAS, 5G_TSPEC and Higher Layer Stream ID for 5G. The QoS traffic stream setup is initiated from the non-AP STA with new set of QoS Negotiation Request/Response MAC layer messages. The QoS Negotiation Request carries same set of parameters as the ADDTS

Request described above, which includes TSPEC, TCLAS, 5G_TSPEC and the Higher Layer Stream ID for 5G. Multiple rounds of QoS Negotiation Request/Response exchange could happen to establish QoS traffic stream for UL and DL IPsec SA.

TABLE 2
IPSec Information Element Format for IPv4:

| | Element | | IPsec | IP Security | Source IP | Destination |
|---|---|---|---|---|---|---|
| Field: | ID | Length | SPI | Protocol | Address | IP Addres |
| Octets: | 1 | 1 | 4 | 1 | 4 | 4 |

TABLE 3
IPSec Information Element Format for IPv6:

| | Element | | IPsec | IP Security | Source IP | Destination |
|---|---|---|---|---|---|---|
| Field: | ID | Length | SPI | Protocol | Address | IP Addres |
| Octets: | 1 | 1 | 4 | 1 | 16 | 16 |

In one or more embodiments, the fields of Tables 2 and 3 may be as follows: IPsec SPI: Set to the Security Parameter Index (SPI) for the IPsec security association [6]. This could refer to SPI for the IPsec child SA or the SPI for the signaling IPsec SA established between N3IWF/TNGF and UE. IPsec Security Protocol: Indicates type of IPsec protocol set to ESP (Encapsulated Security Protocol). Source IP Address: Source IP address for the DL packet on the IPsec child SA. Destination IP Address: Destination IP address for the DL packet on the IPsec child.

In one or more embodiments, if the QoS negotiation and traffic stream setup is successful for both UL and DL IPsec SAs indicated by success status code in the QoS Negotiation Response frame, the non-AP STA sends a QoS Reservation Response frame to the AP with the Higher Layer Stream ID for 5G and indicating success status code for the QoS negotiation. If the TS setup negotiation fails, the non-AP STA sends a QoS Reservation Response frame to the AP with the Higher Layer Stream ID for 5G and indicating a failure status code for the QoS negotiation.

In one or more embodiments, after successful QoS negotiation and traffic streams setup for IPsec SAs: (1) The WLAN AP will identify the DL 5G traffic carried over IPsec child SA or IPsec signaling SA based on TCLAS traffic filters (SPI, destination IP address and security protocol ID) for the downlink IPsec SA and will map the DL 5G traffic to the User Priority as specified in the TCLAS or TSPEC element for the associated traffic stream. (2) The WLAN STA will identify the UL 5G traffic carried over IPsec child SA or IPsec signaling SA based on TCLAS traffic filters (SPI, destination IP address and security protocol ID) for the uplink IPsec SA and will map the UL 5G traffic to the User Priority as specified in the TCLAS or TSPEC element for the associated traffic stream.

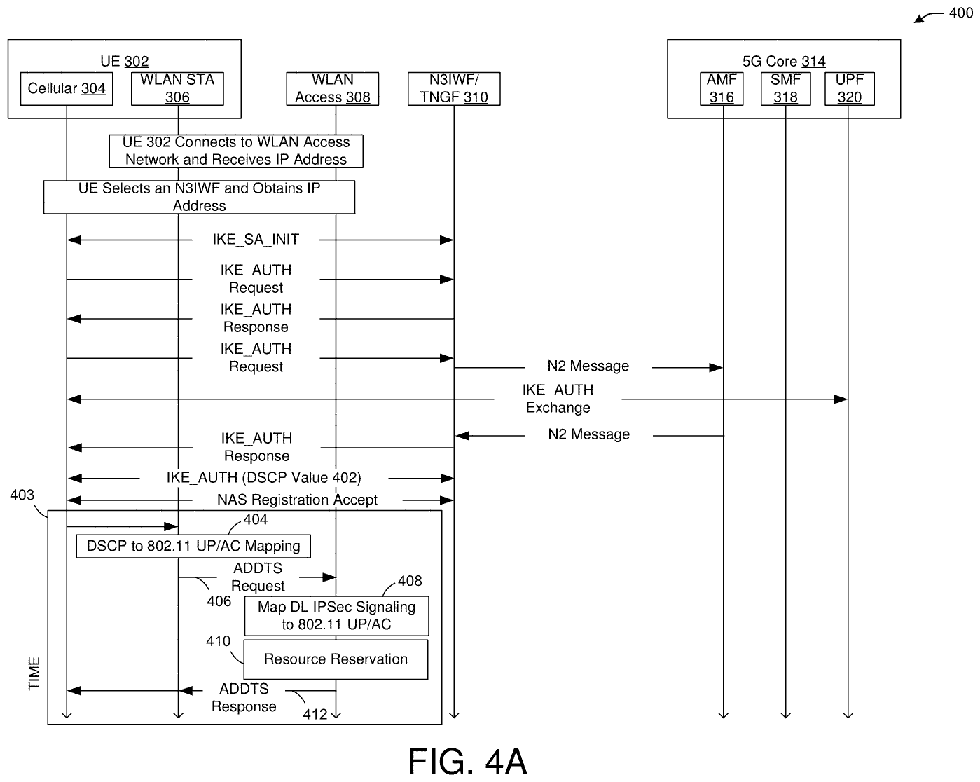

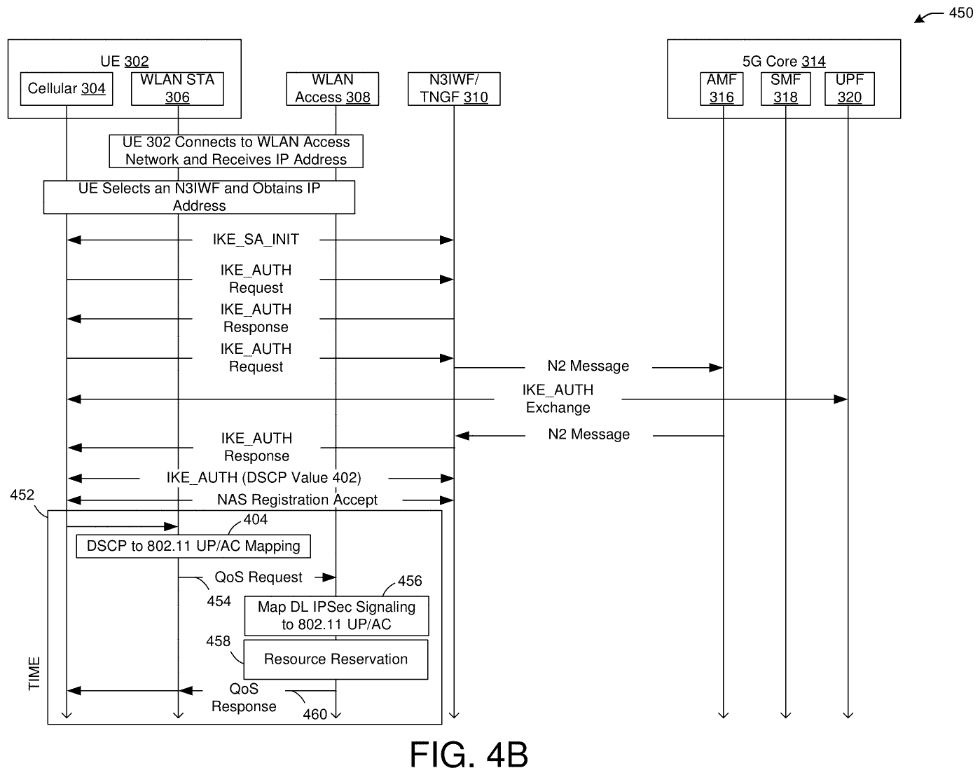

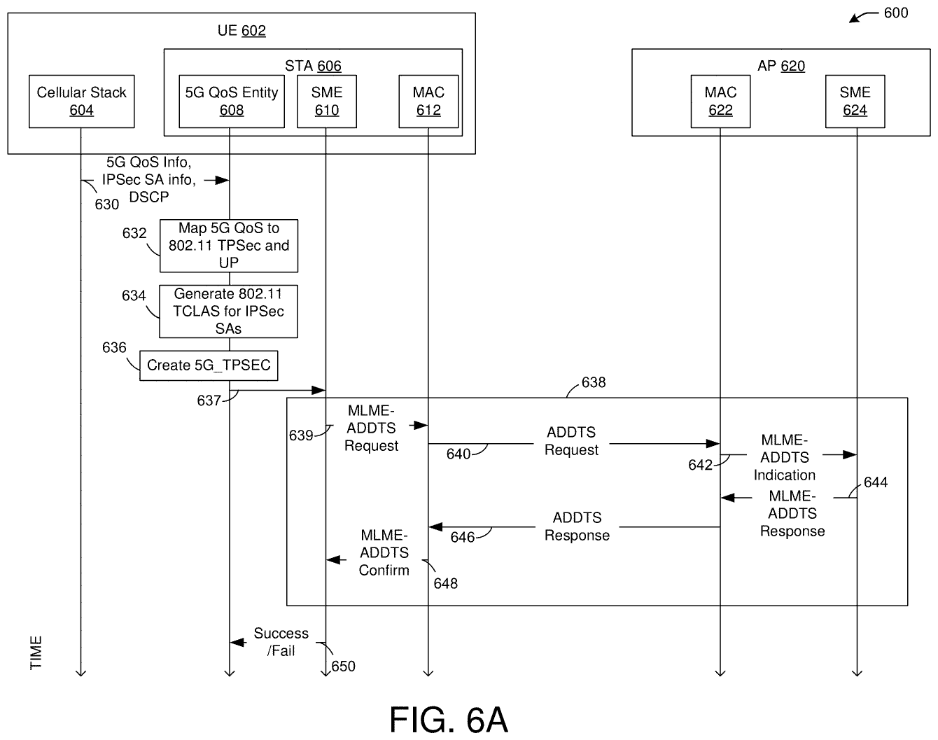

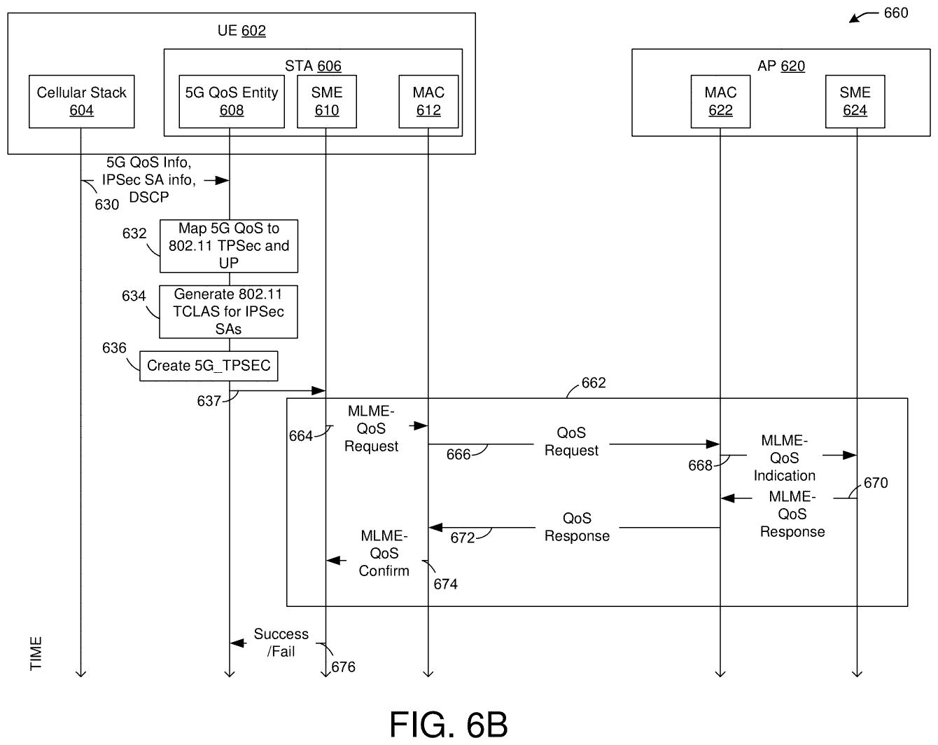

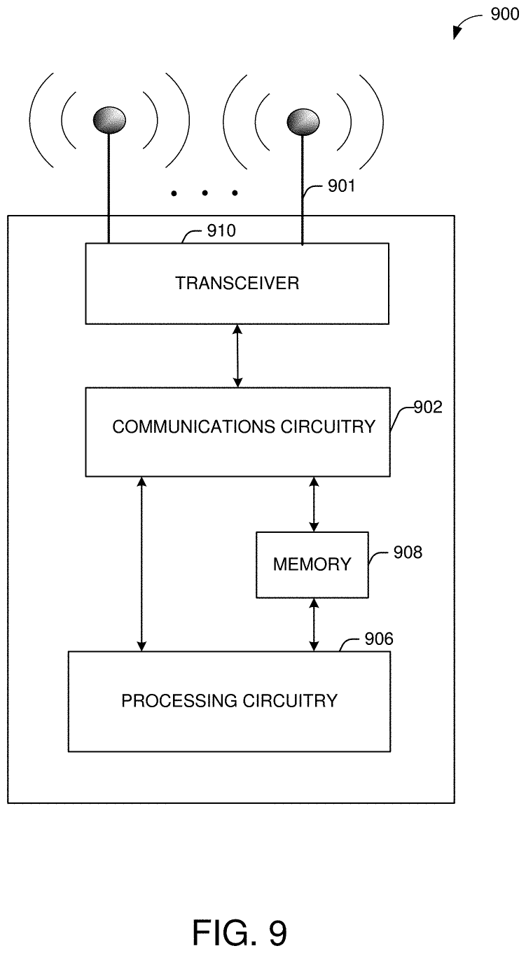

In one or more embodiments, the present disclosure provides a definition for new and updated elements for the QoS negotiation procedure. Higher Layer Stream ID for 5G: The Higher Layer Stream ID element identifies a stream from the higher layer protocol. This element is used to bind messages that are exchanged to complete the AP-initiated TS setup procedure. Higher Layer Stream ID format is defined in IEEE 802.11-2016 FIG. 9-545 as shown in Tables 2 and 3. A new higher layer protocol ID value needs to be defined for 5G NAS protocol as shown Table 4 using one of the existing Reserved value. 5G_TSPEC Element: The 5G_TSPEC element is a new 802.11 element which specifies 5G QoS flow characteristics and parameters as defined in the 3GPP specs. The 5G_TSPEC element definition is captured in FIG. 6-4. The Max Flow Bit Rate for DL and UL fields, the Guaranteed Flow Bit Rate for DL and UL fields and the Max Packet Loss Rate for DL and UL fields are included only for the GBR and the Delay-Critical GBR resource type.

TABLE 4
Higher Layer Protocol ID Definition Updates:

| Protocol ID | Protocol | Description |
|---|---|---|
| 0 | Reserved | |
| 1 | IEEE 802.1Q SRP | Protocol is IEEE 802.1Q SRP, |
| | | and the corresponding |
| | | Stream ID is 8 octets long. |
| 2 | 3GPP 5G NAS | Protocol is 3GPP 5G NAS |
| | | and the corresponding |
| | | Stream ID is 1 octet long |
| | | PDU Session ID. |
| 3-220 | Reserved | |
| 221 | Vendor Specific | Corresponding Organization |
| | | Identifier field is included in |
| | | the element. |
| 222-255 | Reserved | |

In one or more embodiments, embodiments of this disclosure are directed QoS differentiation within the Wi-Fi access for 5G user data flows and 5G NAS signaling carried over Wi-Fi access, to ensure end-to-end Quality of Service over Wi-Fi in 5G systems. Some embodiments may be used for both untrusted as well as trusted Wi-Fi integration with 5G systems.

In one or more embodiments, to support QoS differentiation over untrusted WLAN access where DSCP markings may get reset by the intermediate routers between N3IWF and WLAN AP, embodiments of the present disclosure may help provide a device-centric QoS system to negotiate QoS prioritization for IPsec tunnels established to carry 5G QoS flows using SPI (Security Parameter Index) and traffic identifiers. Some embodiments may not rely on in-band DSCP marking for QoS prioritization within WLAN and works for both untrusted and trusted WLAN integration with 5G. Some embodiments may also help provide QoS differentiation for 5G signaling traffic over WLAN access by negotiating QoS prioritization for signaling IPsec tunnel established to carry 5G NAS signaling traffic. Some embodiments may be directed to sending 5G QoS related information to WLAN AP to provide additional QoS characteristics and parameters for resource allocation/reservation within WLAN network for 5G flows.

Some vendors and operators are may deploy 5G systems possibly with Wi-Fi for data transfer for applications in enterprises, homes, industrial automation and public hotspots. Embodiments of the present disclosure helps enable QoS differentiation within Wi-Fi access for the 5G user data and the 5G signaling carried over the Wi-Fi access in 5G systems. This can ensure end-to-end Quality of Service for 5G services/applications carried over Wi-Fi access, enabling seamless usage of 3GPP and Wi-Fi radios, thus providing improved user experience. In addition, the proposed scheme enables providing 5G QoS characteristics and parameters to WLAN AP which can enable better resource allocation/reservation for 5G flows within Wi-Fi, leading to overall improved resource usage and operation of the WLAN network. The proposed QoS differentiation mechanism can be used for both untrusted as well as trusted WLAN integration model with 5G.

Embodiments for QoS differentiation in this disclosure can be proposed as part of IEEE, WFA or 3GPP specifications. The product literature will mention whether the product complies to 5G and Wi-Fi specifications.

In one or more embodiments, as part of the Multi-Access (MA) PDU session establishment procedures as defined in 3GPP TS 23.502, if the UE is registered over both NR and Wi-Fi access, two separate N3/N9 tunnels are established between the 5G Core and 3GPP access and Wi-Fi access for the PDU data transfer. The gateway functions N3IWF or TNGF create IPsec child SAs (security associations) in a tunnel mode with the UE to carry 5G user plane traffic over the Wi-Fi access. Also, during a single access PDU session establishment over Wi-Fi access, the gateway functions N3IWF or TNGF create IPsec child SAs with the UE to carry 5G traffic over Wi-Fi.

The current QoS model for Wi-Fi in 5G systems makes use of in-band DSCP marking to achieve QoS differentiation in the WLAN access. Because there are deployments where DSCP marking may not be preserved and reset by intermediate routers, there is a need for QoS management which does not reply on in-band DSCP marking.

In one or more embodiments, during the multi-access PDU session establishment or the single access PDU session establishment involving Wi-Fi access, the UE can initiate QoS management with the WLAN AP for 5G flows to be carried over Wi-Fi access in 5G Systems, without the need for in-band DSCP marking for QoS differentiation. Two options are possible for supporting QoS management within the WLAN access for 5G flows: Option 1: QoS Management with enhancements to 802.11 ADDTS Request/Response. Option 2: QoS Management with new MAC layer messages.

In one or more embodiments, the present disclosure provides steps for QoS management within WLAN for MA PDU session. These enhancements for QoS management are also applicable for single access PDU session established over Wi-Fi. During the IKEv2 child SA establishment, the 5G QoS characteristics are sent to the UE in the 5G_QOS_INFO notify payload as defined in the current technical standards. This payload may also specify a DSCP value to be used for marking the traffic sent over the IPsec child SA. If a DSCP value is provided in the 5G_QOS_INFO payload, the UE uses that for mapping 5G QoS (5QI) to DSCP value for the IPsec SA. If a DSCP value is not provided, then the UE maps the 5QI to a DSCP value based on local configuration e.g. as per mapping in IETF draft specification. The cellular stack on the UE sends 5QI to DSCP mapping as well as the 5G QoS characteristics and parameters received in the 5G_QOS_INFO payload to the WLAN STA on the device. The WLAN STA maps the DSCP value to 802.11 User Priority which gets mapped to 802.11 Access Categories as defined in the IEEE 802.11-2016 specification. Alternatively, the cellular stack sends the 5G QoS characteristics and parameters to the WLAN STA on the device, which then maps those to 802.11 UP based on local configuration defining mapping between 5G QoS (5QI) to 802.11 UP.

In one or more embodiments, to achieve QoS prioritization for 5G user data flows, the WLAN STA can use 802.11 Admission Control feature with ADDTS Request/Response messaging to negotiate QoS with WLAN AP. The STA maps some of the 5G QoS parameters to 802.11 TSPEC parameters and also includes User Priority requested for the traffic flow in TSPEC. In addition, following two new Elements are defined to be carried in the ADDTS Request message: IPsec Info Element—provides parameters to identify an IPsec SA carrying DL 5G traffic. This is used by the WLAN AP to match DL 5G traffic for QoS prioritization. 5G_TSPEC Element—provides 5G QoS parameters to WLAN AP. Only some of the 5G QoS parameters can be directly mapped to TSPEC parameters. It is useful to provide other 5G QoS parameters to the WLAN AP to enable resource allocation/reservation for 5G flows. This is an optional element which can be included to provide additional 5G QoS parameters to WLAN AP, besides the parameters sent as part of TSPEC.

In one or more embodiments, the STA sends ADDTS Request to WLAN AP for 5G DL traffic flow containing following: (1) An IPsec Info Element with parameters to identify an IPsec child SA carrying 5G traffic on the DL. (2) A TSPEC Element specifying parameters derived from 5G QoS characteristics and parameters. The TSPEC element includes the User Priority requested for the DL traffic on the IPsec child SA. (3) A 5G_TSPEC Element to carry all the 5G QoS characteristics and parameters.

In one or more embodiments, the WLAN AP performs admission control for the 5G traffic flow carried over IPsec child SA (IPsec child SA traffic flow) based on the information received in the ADDTS Request message. If it can admit the traffic flow, the WLAN AP maps DL IPsec child SA traffic to the User Priority specified in the ADDTS Request. The WLAN AP may also do resource reservation for the IPsec child SA traffic flow based on 5G QoS parameters received in TSPEC and 5G_TSPEC elements. The WLAN AP sends an ADDTS Response message to the STA. The WLAN AP can reject ADDTS Request from UE, if it cannot admit flow for the requested User Priority. The success/failure of traffic admission over WLAN access is communicated to the cellular stack on the UE.

In one or more embodiments, if the ADDTS Request was successful for the 5G IPsec child SA, then the UE sends a successful response for the IKEv2 Create_Child_SA Request to N3IWF or TNGF. If the ADDTS Request failed, then the UE sends a failure response for the IKEv2 Create_Child_SA Request and the child SA creation fails.

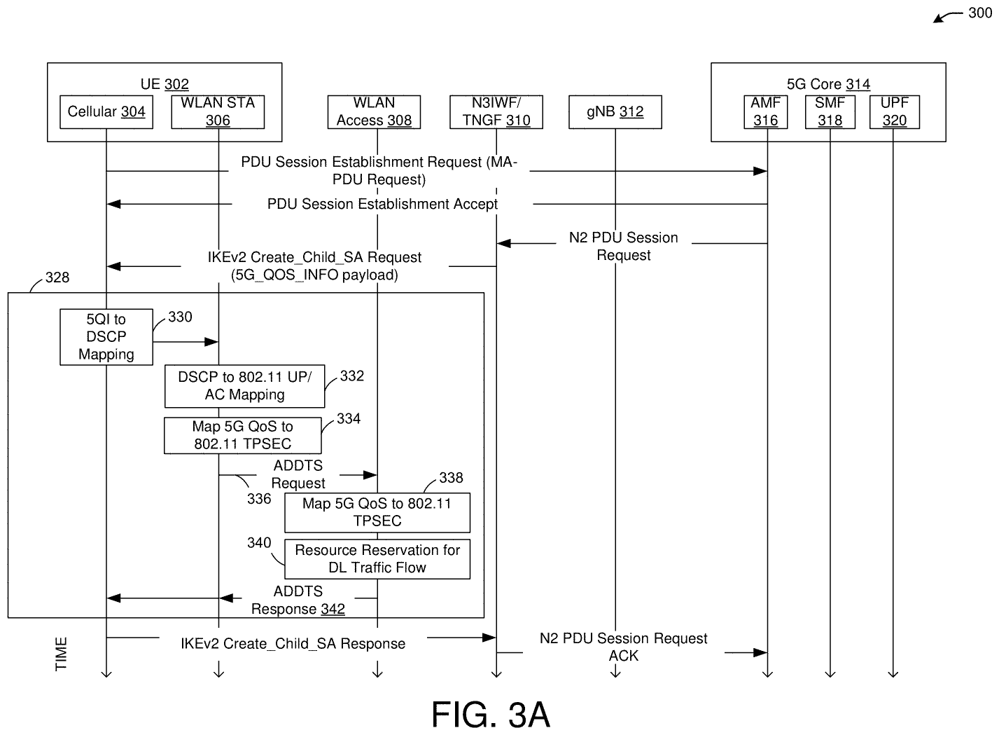

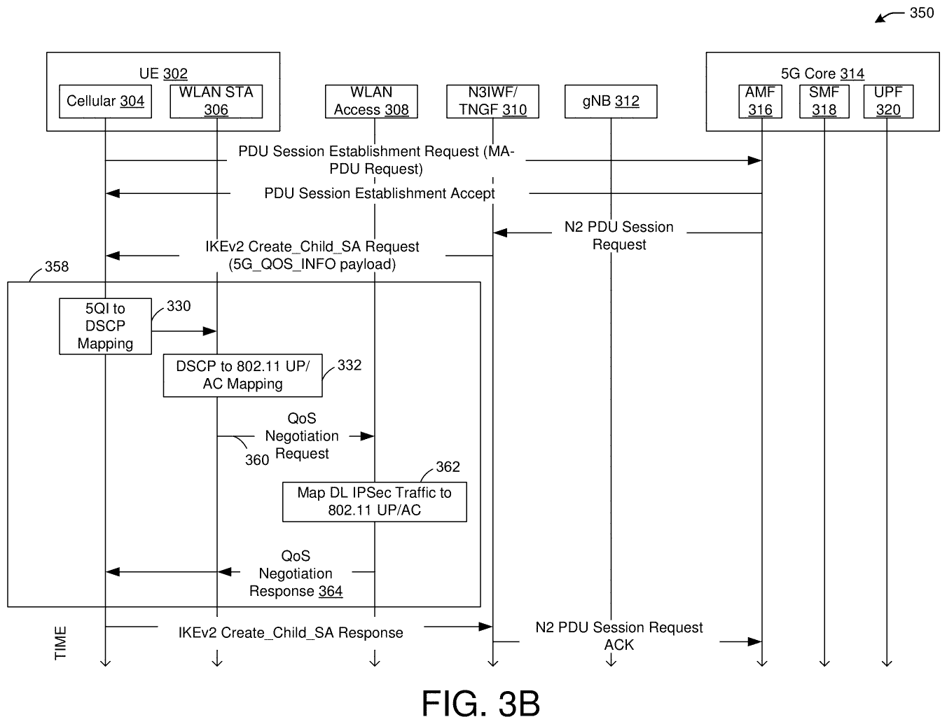

In one or more embodiments, the IPsec Info element is a new 802.11 element which includes fields as captured in FIG. 6-3. This element is defined for both IPv4 and IPv6. The WLAN AP can use a combination of SPI, Source IP Address and Destination IP Address to match DL traffic for QoS prioritization.

In one or more embodiments, Table 1 provides a proposal for mapping some of the 5G QoS characteristics and parameters to 802.11 TSPEC parameters for including in the ADDTS Request. Using this mapping, the STA generates TSPEC element from the 5G QoS characteristics and parameters received at the UE. Other required TSPEC parameters can be set based on local configured parameter values. The generated TSPEC element is sent in the ADDTS Request message to the WLAN AP.

In one or more embodiments, the 5G_TSPEC element is a new 802.11 element which includes fields as captured in Table 5 below. These fields are 5G QoS characteristics and parameters as defined in clause 5.7 in TS 23.501.

TABLE 5
5G_TSPEC Element Format:

| | | | | | | | | Max |
|---|---|---|---|---|---|---|---|---|
| | | | | | | Packet | | Data |
| | Element | | | Resource | | Delay | Averaging | Burst |
| Field: | ID | Length | 5QI | Type | Priority | Budget | Window | Volume |
| Octets: | 1 | 1 | 1 | 1 | 1 | 4 | 1 | 4 |

| | | | | | Max | Max |
|---|---|---|---|---|---|---|
| | Max | Max | Guaranteed | Guaranteed | Packet | Packet |
| | Flow Bit | Flow Bit | Flow Bit | Flow Bit | Loss | Loss |
| Field: | Rate DL | Rate UL | Rate DL | Rate UL | Rate DL | Rate UL |
| Octets: | 4 | 4 | 4 | 4 | 4 | 4 |

In one or more embodiments, the present disclosure provides steps for QoS management within WLAN for 5G QoS flows with option 2 (QoS Management with new MAC Layer Messages). In this option, a new pair of 802.11 MAC layer messages (QoS Negotiation Request/Response) are defined which STA uses to negotiate QoS for IPsec child SA with the WLAN AP. The UE maps the 5G QoS (5QI) to DSCP value and the WLAN STA maps the DSCP to 802.11 UP/AC. Alternatively, the 5G QoS characteristics and parameters are sent to WLAN STA on the device, which then maps those to 802.11 UP based on local configuration defining mapping between 5G QoS (5QI) to 802.11 UP. The WLAN STA sends QoS Negotiation Request message with IPsec Info element, Requested User Priority and 5G QoS info to the WLAN AP. The WLAN AP performs admission control for the requested IPsec child SA and maps DL traffic for the child SA to requested UP/AC. The WLAN AP may use 5G QoS info provided for resource allocation/reservation for the IPsec child SA traffic flow. The WLAN AP sends a successful QoS Negotiation Response message to the WLAN STA if it can admit the requested UP for the IPsec child SA, else it sends a failure response.

In one or more embodiments, the QoS management approach described above for 5G user data flows can also be applied for the 5G NAS signaling data delivered over the signaling IPsec SA established between N3IWF/TNGF and UE. The present disclosure provides steps for the signaling IPsec SA establishment as part of the UE registration with the 5G core, and enhancements to that procedure to support QoS management for the signaling IPsec SA. Enabling QoS differentiation for signaling IPsec SA over WLAN can provide QoS benefit to meet requirements for different services and applications.

In one or more embodiments, during the signaling IPsec SA establishment, a DSCP value can be sent to the UE using a Notify Payload over IKE_AUTH messaging to mark NAS signaling data packets with that DSCP value in the IP header. If UE does not receive any DSCP value, UE can be locally configured with a DSCP value to be used for the signaling IPsec SA. After UE registration is completed, the UE triggers QoS negotiation with the WLAN AP for the Signaling IPsec SA.

In one or more embodiments, first the WLAN STA maps the DSCP value to 802.11 User Priority which gets mapped to 802.11 Access Categories as defined in IEEE 802.11-2016 specification. Alternatively, the WLAN STA may be configured with a UP to be used for signaling IPsec SA. Next, the WLAN STA sends an add traffic stream (ADDTS) Request to WLAN AP to negotiate QoS prioritization for the signaling IPsec SA (e.g. AC_VO or AC_VI). The ADDTS Request includes a TSPEC IE which is generated based on local configured parameter values for the 5G signaling data and includes 802.11 User Priority requested for the signaling IPsec SA. The ADDTS Request also includes IPsec Info element to specify details for the signaling IPsec SA. The WLAN AP sends an ADDTS Response success message to the STA if it can admit the requested User Priority, resulting in QoS prioritization for NAS signaling data within WLAN. If the requested User Priority cannot be admitted, then a failure response is sent to the STA in which case the NAS signaling data will get delivered using AC_BE (Best Effort) access category over WLAN.

In one or more embodiments, the QoS Management for 5G signaling IPsec SA can also be achieved using new 802.11 MAC layer messages as shown in the present disclosure. In this option, the WLAN STA sends the QoS Negotiation Request to WLAN AP to negotiate QoS prioritization for the signaling IPsec SA (e.g. AC_VO or AC_VI). The request includes 802.11 User Priority requested for the signaling IPsec SA and also includes IPsec Info element to specify details for the signaling IPsec SA. The WLAN AP sends a successful QoS Negotiation Response message to the STA if it can admit the requested User Priority, resulting in QoS prioritization for NAS signaling data within WLAN. If the requested User Priority cannot be admitted, then a failure response is sent to the STA.

In one or more embodiments, the present disclosure describes a WLAN STA-initiated (device centric) QoS negotiation mechanism within the WLAN access to establish QoS traffic streams and provide QoS differentiation for 5G user data flows and 5G signaling, to ensure end-to-end Quality of Service over Wi-Fi in 5G systems. The proposed mechanism can be used for both trusted and untrusted WLAN access integrated within a 5G system.

In one or more embodiments, to support QoS differentiation for 5G flows carried over a Wi-Fi access integrated with 5G system, the present disclosure proposes a device centric QoS management scheme within WLAN to negotiate QoS prioritization and setup QoS traffic streams for 5G traffic carried over IPsec tunnels. The present disclosure defines 5G QoS related information to be sent to the WLAN STA on the UE and how this QoS information can be used within WLAN access to provide QoS differentiation for IPsec SAs carrying 5G traffic.

In one or more embodiments, the present disclosure enables QoS negotiation and QoS traffic stream setup for 5G traffic (5G user data and 5G signaling) carried over IPsec tunnels established over Wi-Fi access in 5G systems. This can ensure end-to-end Quality of Service for 5G services/applications carried over Wi-Fi access, enabling seamless usage of 3GPP and Wi-Fi radios, thus providing improved user experience for 5G services.

In one or more embodiments, the present disclosure provides WLAN Reference Architecture for Device Centric QoS Management for 5G Traffic. For example, the present disclosure provides a WLAN reference architecture model for device centric QoS management related to 5G user data flows and signaling. A higher layer entity called ‘5G QoS Entity’ is co-located within the WLAN STA to provide support for device centric QoS management for 5G traffic. The 5G QoS Entity receives 5G QoS related information from the cellular stack for 5G user data flows and 5G signaling. The 5G QoS related information includes 5G QoS flow characteristics and parameters, IPsec SA (security association) info to identify IPsec child SAs and IPsec signaling SA established over WLAN to carry 5G traffic and any assigned DSCP value for IPsec SAs.

In one or more embodiments, the IPsec SA info includes information to identify IPsec security associations in each direction for UL and DL traffic. For each IPsec SA (uplink SA and downlink SA) the SPI (Security Parameter Index), the destination IP address and security protocol ID information is provided.

In one or more embodiments, the 5G QoS Entity on the WLAN STA can provide device centric QoS management for 5G traffic for both trusted and untrusted WLAN access integrated within a 5G system.

In one or more embodiments, the 5G QoS Entity on the WLAN STA initiates QoS negotiation with the SME after it receives 5G QoS related information from the cellular stack. The 5G QoS Entity maps the 5G QoS flow characteristics and parameters to 802.11 QoS Traffic Specification (TSPEC) and 802.11 User Priority. The DSCP value received can be taken into account to determine mapping of 5G QoS to 802.11 User Priority. The TSPEC can specify desired QoS parameters for traffic streams (TS) in both UL and DL direction if same QoS parameters apply in both directions, or separate TSPEC can be generated to specify QoS parameters for traffic streams in UL and DL direction.

In one or more embodiments, the 5G QoS Entity also creates two separate 802.11 Traffic Classification (TCLAS) elements, one each for UL and DL traffic, from the IPsec SA information received from the cellular stack to indicate traffic filters for the IPsec SAs carrying 5G traffic.

In one or more embodiments, the 5G QoS Entity on WLAN STA provides following information to the SME for QoS negotiation for 5G traffic: (1) 802.11 QoS Traffic Specification (TSPEC). (2) 802.11 Traffic Classification (TCLAS) elements indicating traffic filters for the IPsec SAs in UL and DL carrying 5G traffic. (3) User Priority for IPsec SAs in UL and DL, provided as part of TCLAS element. (4) 5G_TSPEC element with detailed 5G QoS flow characteristics and parameters.

In one or more embodiments, after receiving QoS negotiation trigger from the 5G QoS Entity, the SME on WLAN STA triggers QoS negotiation and traffic stream (TS) setup for IPsec SAs both in the UL and DL direction using the TS Setup procedure described in 802.11 specification with enhancements as captured herein.

In one or more embodiments, the device centric QoS management model described herein is also applicable for Wi-Fi only devices with 3GPP NAS functionality for connecting to 5G Core over untrusted or trusted WLAN access. The 3GPP stack on such devices refers to 3GPP NAS+NWu/NWt interface functionality as defined in the 3GPP specifications.

In one or more embodiments, the present disclosure provides QoS Negotiation and Traffic Stream setup within WLAN for IPsec SAs carrying 5G Traffic. There are two options for device centric QoS negotiation and to establish QoS traffic streams (TS) for carrying 5G traffic over IPsec SAs within WLAN access. Option 1: QoS negotiation with enhancements to 802.11 QoS management frames. Option 2: QoS negotiation with new QoS management messages

In one or more embodiments, the present disclosure provides an STA initiated QoS negotiation and QoS traffic Stream (TS) Setup for 5G traffic flows with WLAN access. The 5G QoS Entity receives 5G QoS related information from the cellular stack on the UE as described above. The 5G QoS related information includes 5G QoS flow characteristics and parameters, IPsec SA (security association) info to identify IPsec child SAs and signaling SA established over WLAN to carry 5G traffic and any assigned DSCP value for IPsec SAs.

In one or more embodiments, after receiving 5G QoS related information, the 5G QoS Entity on the STA triggers the QoS traffic stream setup procedure by sending a QoS TS Setup Request to the local SME. This message includes one or more TSPEC element (with QoS parameters for UL and DL TS), TCLAS elements (for IPsec SAs carrying 5G traffic and associated 802.11 User Priority) and 5G_TSPEC element (providing 5G QoS flow characteristics and parameters). Two separate TCLAS elements are included to provide filtering information for identifying IPsec SAs carrying 5G traffic in UL and DL.

In one or more embodiments, the SME starts the QoS Traffic Stream (TS) negotiation procedure with the AP by initiating the MLME-ADDTS Request primitive with the MAC layer, which starts the QoS negotiation by exchanging ADDTS Request/Response with the AP to setup the UL and DL traffic streams as per TSPEC and TCLAS parameters. Multiple ADDTS Request/Response exchange happens with the AP to setup QoS TS in both UL and DL direction. The ADDTS Request message includes the TSPEC element and the TCLAS element specifying traffic filters and User Priority for the corresponding IPsec SA (UL or DL SA). The TCLAS element might not be included for IPsec SA carrying UL traffic, in which case the User Priority is included as part of the TSPEC element. The ADDTS Request also includes the 5G_TSPEC element received from the 5G QoS Entity, which provides detailed 5G QoS flow characteristics and parameters which can be used by the AP along with TSPEC for resource allocation/reservation for 5G flows.

In one or more embodiments, the AP follows the procedure defined in the 802.11 specification for TS setup based on received TSPEC and TCLAS elements and additionally takes into account 5G_TSPEC element received from the STA. If the QoS TS setup completes successfully on the AP, it sends a success indication to the STA in the ADDTS Response message. If the QoS TS setup fails on the AP, it sends a failure indication to the STA in the ADDTS Response message. The SME on the STA sends a QoS TS Setup Response message to the 5G QoS Entity indicating the success/failure outcome of QoS negotiation for the IPsec SAs carrying 5G traffic.

In one or more embodiments, Option 2 for QoS negotiation with new QoS management messages includes a WLAN STA initiated QoS negotiation procedure for 5G traffic to setup QoS traffic streams (TS) with new set of QoS management messages defined. In this option, new set of QoS Negotiation Request/Response messages are defined to initiate QoS traffic stream setup from the WLAN STA. The QoS Negotiation Request includes same set of parameters as the ADDTS Request described above, which includes TSPEC, TCLAS and 5G_TSPEC elements. Multiple rounds of QoS Negotiation Request/Response exchange could happen to establish QoS traffic stream for UL and DL IPsec SA.

In one or more embodiments, the AP follows the procedure defined in the 802.11 specification for TS setup based on received TSPEC and TCLAS elements and additionally takes into account 5G_TSPEC element received from the STA. If the QoS TS setup is successful on the AP, it sends a success indication to the STA in the QoS Negotiation Response message. If the QoS TS setup fails on the AP, it sends a failure indication to the STA in the QoS Negotiation Response message. The SME on the STA sends a QoS TS Setup Response message to the 5G QoS Entity indicating the success/failure outcome of QoS negotiation for the IPsec SAs carrying 5G traffic.

In one or more embodiments, after successful QoS negotiation and traffic streams setup for IPsec SAs: (1) The WLAN AP will identify the DL 5G traffic carried over IPsec child SA or IPsec signaling SA based on TCLAS traffic filters (SPI, destination IP address and security protocol ID) for the downlink IPsec SA and will map the DL 5G traffic to the User Priority as specified in the TCLAS or TSPEC element for the associated traffic stream. (2) The WLAN STA will identify the UL 5G traffic carried over IPsec child SA or IPsec signaling SA based on TCLAS traffic filters (SPI, destination IP address and security protocol ID) for the uplink IPsec SA and will map the UL 5G traffic to the User Priority as specified in the TCLAS or TSPEC element for the associated traffic stream.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

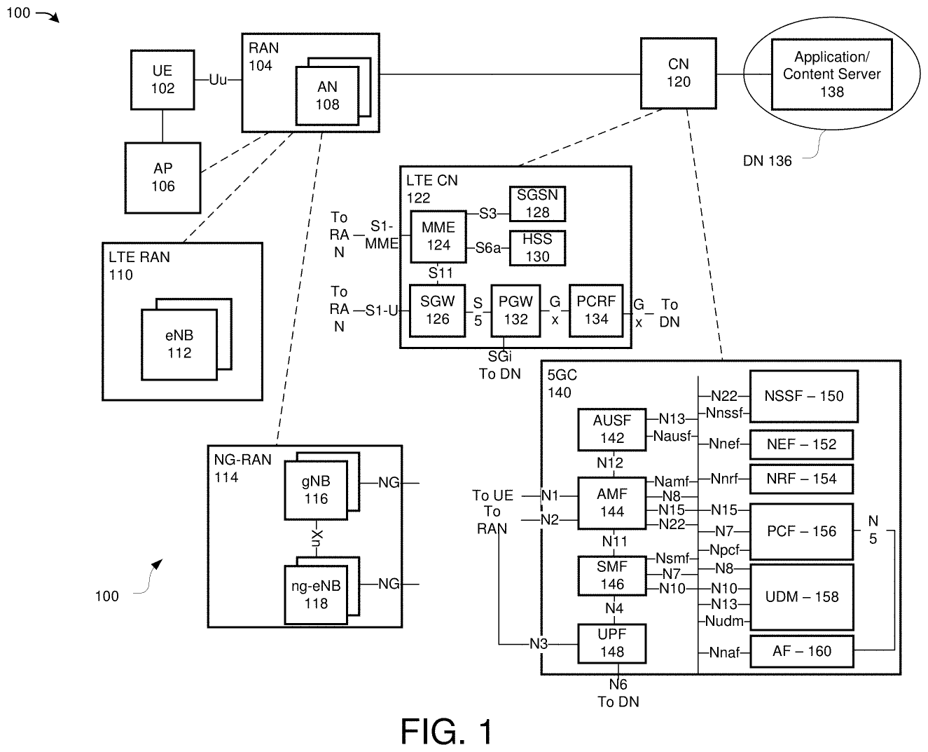

FIG. 1 illustrates a network 100 in accordance with various embodiments. The network 100 may operate in a manner consistent with 3GPP technical specifications for LTE or 5G/NR systems. However, the example embodiments are not limited in this regard and the described embodiments may apply to other networks that benefit from the principles described herein, such as future 3GPP systems, IEEE 802.11 systems (Wi-Fi), or the like.

The network 100 may include a UE 102, which may include any mobile or non-mobile computing device designed to communicate with a RAN 104 via an over-the-air connection. The UE 102 may be communicatively coupled with the RAN 104 by a Uu interface. The UE 102 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 100 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 102 may additionally communicate with an AP 106 via an over-the-air connection. The AP 106 may manage a WLAN connection, which may serve to offload some/all network traffic from the RAN 104. The connection between the UE 102 and the AP 106 may be consistent with any IEEE 802.11 protocol, wherein the AP 106 could be a wireless fidelity (Wi-Fi®) router. In some embodiments, the UE 102, RAN 104, and AP 106 may utilize cellular-WLAN aggregation (for example, LWA/LWIP). Cellular-WLAN aggregation may involve the UE 102 being configured by the RAN 104 to utilize both cellular radio resources and WLAN resources.

The RAN 104 may include one or more access nodes, for example, AN 108. AN 108 may terminate air-interface protocols for the UE 102 by providing access stratum protocols including RRC, PDCP, RLC, MAC, and L1 protocols. In this manner, the AN 108 may enable data/voice connectivity between CN 120 and the UE 102. In some embodiments, the AN 108 may be implemented in a discrete device or as one or more software entities running on server computers as part of, for example, a virtual network, which may be referred to as a CRAN or virtual baseband unit pool. The AN 108 be referred to as a BS, gNB, RAN node, eNB, ng-eNB, NodeB, RSU, TRxP, TRP, etc. The AN 108 may be a macrocell base station or a low power base station for providing femtocells, picocells or other like cells having smaller coverage areas, smaller user capacity, or higher bandwidth compared to macrocells.

In embodiments in which the RAN 104 includes a plurality of ANs, they may be coupled with one another via an X2 interface (if the RAN 104 is an LTE RAN) or an Xn interface (if the RAN 104 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 104 may each manage one or more cells, cell groups, component carriers, etc. to provide the UE 102 with an air interface for network access. The UE 102 may be simultaneously connected with a plurality of cells provided by the same or different ANs of the RAN 104. For example, the UE 102 and RAN 104 may use carrier aggregation to allow the UE 102 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 104 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 102 or AN 108 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 104 may be an LTE RAN 110 with eNB s, for example, eNB 112. The LTE RAN 110 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 104 may be an NG-RAN 114 with gNBs, for example, gNB 116, or ng-eNBs, for example, ng-eNB 118. The gNB 116 may connect with 5G-enabled UEs using a 5G NR interface. The gNB 116 may connect with a 5G core through an NG interface, which may include an N2 interface or an N3 interface. The ng-eNB 118 may also connect with the 5G core through an NG interface, but may connect with a UE via an LTE air interface. The gNB 116 and the ng-eNB 118 may connect with each other over an Xn interface.

In some embodiments, the NG interface may be split into two parts, an NG user plane (NG-U) interface, which carries traffic data between the nodes of the NG-RAN 114 and a UPF 148 (e.g., N3 interface), and an NG control plane (NG-C) interface, which is a signaling interface between the nodes of the NG-RAN 114 and an AMF 144 (e.g., N2 interface).

The NG-RAN 114 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 102 can be configured with multiple BWPs where each BWP configuration has a different SCS. When a BWP change is indicated to the UE 102, the SCS of the transmission is changed as well. Another use case example of BWP is related to power saving. In particular, multiple BWPs can be configured for the UE 102 with different amount of frequency resources (for example, PRBs) to support data transmission under different traffic loading scenarios. A BWP containing a smaller number of PRBs can be used for data transmission with small traffic load while allowing power saving at the UE 102 and in some cases at the gNB 116. A BWP containing a larger number of PRBs can be used for scenarios with higher traffic load.

The RAN 104 is communicatively coupled to CN 120 that includes network elements to provide various functions to support data and telecommunications services to customers/subscribers (for example, users of UE 102). The components of the CN 120 may be implemented in one physical node or separate physical nodes. In some embodiments, NFV may be utilized to virtualize any or all of the functions provided by the network elements of the CN 120 onto physical compute/storage resources in servers, switches, etc. A logical instantiation of the CN 120 may be referred to as a network slice, and a logical instantiation of a portion of the CN 120 may be referred to as a network sub-slice.

In some embodiments, the CN 120 may be an LTE CN 122, which may also be referred to as an EPC. The LTE CN 122 may include MME 124, SGW 126, SGSN 128, HSS 130, PGW 132, and PCRF 134 coupled with one another over interfaces (or “reference points”) as shown. Functions of the elements of the LTE CN 122 may be briefly introduced as follows.

The MME 124 may implement mobility management functions to track a current location of the UE 102 to facilitate paging, bearer activation/deactivation, handovers, gateway selection, authentication, etc.

The SGW 126 may terminate an S1 interface toward the RAN and route data packets between the RAN and the LTE CN 122. The SGW 126 may be a local mobility anchor point for inter-RAN node handovers and also may provide an anchor for inter-3GPP mobility. Other responsibilities may include lawful intercept, charging, and some policy enforcement.

The SGSN 128 may track a location of the UE 102 and perform security functions and access control. In addition, the SGSN 128 may perform inter-EPC node signaling for mobility between different RAT networks; PDN and S-GW selection as specified by MME 124; MME selection for handovers; etc. The S3 reference point between the MME 124 and the SGSN 128 may enable user and bearer information exchange for inter-3GPP access network mobility in idle/active states.

The HSS 130 may include a database for network users, including subscription-related information to support the network entities' handling of communication sessions. The HSS 130 can provide support for routing/roaming, authentication, authorization, naming/addressing resolution, location dependencies, etc. An S6a reference point between the HSS 130 and the MME 124 may enable transfer of subscription and authentication data for authenticating/authorizing user access to the LTE CN 120.

The PGW 132 may terminate an SGi interface toward a data network (DN) 136 that may include an application/content server 138. The PGW 132 may route data packets between the LTE CN 122 and the data network 136. The PGW 132 may be coupled with the SGW 126 by an S5 reference point to facilitate user plane tunneling and tunnel management. The PGW 132 may further include a node for policy enforcement and charging data collection (for example, PCEF). Additionally, the SGi reference point between the PGW 132 and the data network 1 36 may be an operator external public, a private PDN, or an intra-operator packet data network, for example, for provision of IMS services. The PGW 132 may be coupled with a PCRF 134 via a Gx reference point.

The PCRF 134 is the policy and charging control element of the LTE CN 122. The PCRF 134 may be communicatively coupled to the app/content server 138 to determine appropriate QoS and charging parameters for service flows. The PCRF 132 may provision associated rules into a PCEF (via Gx reference point) with appropriate TFT and QCI.

In some embodiments, the CN 120 may be a 5GC 140. The 5GC 140 may include an AUSF 142, AMF 144, SMF 146, UPF 148, NSSF 150, NEF 152, NRF 154, PCF 156, UDM 158, and AF 160 coupled with one another over interfaces (or “reference points”) as shown. Functions of the elements of the 5GC 140 may be briefly introduced as follows.

The AUSF 142 may store data for authentication of UE 102 and handle authentication-related functionality. The AUSF 142 may facilitate a common authentication framework for various access types. In addition to communicating with other elements of the 5GC 140 over reference points as shown, the AUSF 142 may exhibit an Nausf service-based interface.

The AMF 144 may allow other functions of the 5GC 140 to communicate with the UE 102 and the RAN 104 and to subscribe to notifications about mobility events with respect to the UE 102. The AMF 144 may be responsible for registration management (for example, for registering UE 102), connection management, reachability management, mobility management, lawful interception of AMF-related events, and access authentication and authorization. The AMF 144 may provide transport for SM messages between the UE 102 and the SMF 146, and act as a transparent proxy for routing SM messages. AMF 144 may also provide transport for SMS messages between UE 102 and an SMSF. AMF 144 may interact with the AUSF 142 and the UE 102 to perform various security anchor and context management functions. Furthermore, AMF 144 may be a termination point of a RAN CP interface, which may include or be an N2 reference point between the RAN 104 and the AMF 144; and the AMF 144 may be a termination point of NAS (N1) signaling, and perform NAS ciphering and integrity protection. AMF 144 may also support NAS signaling with the UE 102 over an N3 IWF interface.

The SMF 146 may be responsible for SM (for example, session establishment, tunnel management between UPF 148 and AN 108); UE IP address allocation and management (including optional authorization); selection and control of UP function; configuring traffic steering at UPF 148 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 144 over N2 to AN 108; and determining SSC mode of a session. SM may refer to management of a PDU session, and a PDU session or “session” may refer to a PDU connectivity service that provides or enables the exchange of PDUs between the UE 102 and the data network 136.

The UPF 148 may act as an anchor point for intra-RAT and inter-RAT mobility, an external PDU session point of interconnect to data network 136, and a branching point to support multi-homed PDU session. The UPF 148 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 148 may include an uplink classifier to support routing traffic flows to a data network.

The NSSF 150 may select a set of network slice instances serving the UE 102. The NSSF 150 may also determine allowed NSSAI and the mapping to the subscribed S-NSSAIs, if needed. The NSSF 150 may also determine the AMF set to be used to serve the UE 102, or a list of candidate AMFs based on a suitable configuration and possibly by querying the NRF 154. The selection of a set of network slice instances for the UE 102 may be triggered by the AMF 144 with which the UE 102 is registered by interacting with the NSSF 150, which may lead to a change of AMF. The NSSF 150 may interact with the AMF 144 via an N22 reference point; and may communicate with another NSSF in a visited network via an N31 reference point (not shown). Additionally, the NSSF 150 may exhibit an Nnssf service-based interface.

The NEF 152 may securely expose services and capabilities provided by 3GPP network functions for third party, internal exposure/re-exposure, AFs (e.g., AF 160), edge computing or fog computing systems, etc. In such embodiments, the NEF 152 may authenticate, authorize, or throttle the AFs. NEF 152 may also translate information exchanged with the AF 160 and information exchanged with internal network functions. For example, the NEF 152 may translate between an AF-Service-Identifier and an internal 5GC information. NEF 152 may also receive information from other NFs based on exposed capabilities of other NFs. This information may be stored at the NEF 152 as structured data, or at a data storage NF using standardized interfaces. The stored information can then be re-exposed by the NEF 152 to other NFs and AFs, or used for other purposes such as analytics. Additionally, the NEF 152 may exhibit an Nnef service-based interface.

The NRF 154 may support service discovery functions, receive NF discovery requests from NF instances, and provide the information of the discovered NF instances to the NF instances. NRF 154 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 154 may exhibit the Nnrf service-based interface.

The PCF 156 may provide policy rules to control plane functions to enforce them, and may also support unified policy framework to govern network behavior. The PCF 156 may also implement a front end to access subscription information relevant for policy decisions in a UDR of the UDM 158. In addition to communicating with functions over reference points as shown, the PCF 156 exhibit an Npcf service-based interface.

The UDM 158 may handle subscription-related information to support the network entities' handling of communication sessions, and may store subscription data of UE 102. For example, subscription data may be communicated via an N8 reference point between the UDM 158 and the AMF 144. The UDM 158 may include two parts, an application front end and a UDR. The UDR may store subscription data and policy data for the UDM 158 and the PCF 156, and/or structured data for exposure and application data (including PFDs for application detection, application request information for multiple UEs 102) for the NEF 152. The Nudr service-based interface may be exhibited by the UDR 221 to allow the UDM 158, PCF 156, and NEF 152 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 158 may exhibit the Nudm service-based interface.

The AF 160 may provide application influence on traffic routing, provide access to NEF, and interact with the policy framework for policy control.

In some embodiments, the 5GC 140 may enable edge computing by selecting operator/3rd party services to be geographically close to a point that the UE 102 is attached to the network. This may reduce latency and load on the network. To provide edge-computing implementations, the 5GC 140 may select a UPF 148 close to the UE 102 and execute traffic steering from the UPF 148 to data network 136 via the N6 interface. This may be based on the UE subscription data, UE location, and information provided by the AF 160. In this way, the AF 160 may influence UPF (re)selection and traffic routing. Based on operator deployment, when AF 160 is considered to be a trusted entity, the network operator may permit AF 160 to interact directly with relevant NFs. Additionally, the AF 160 may exhibit an Naf service-based interface.

The data network 136 may represent various network operator services, Internet access, or third party services that may be provided by one or more servers including, for example, application/content server 138.

It is understood that the above descriptions are for purposes of illustration and are not meant to be limiting.

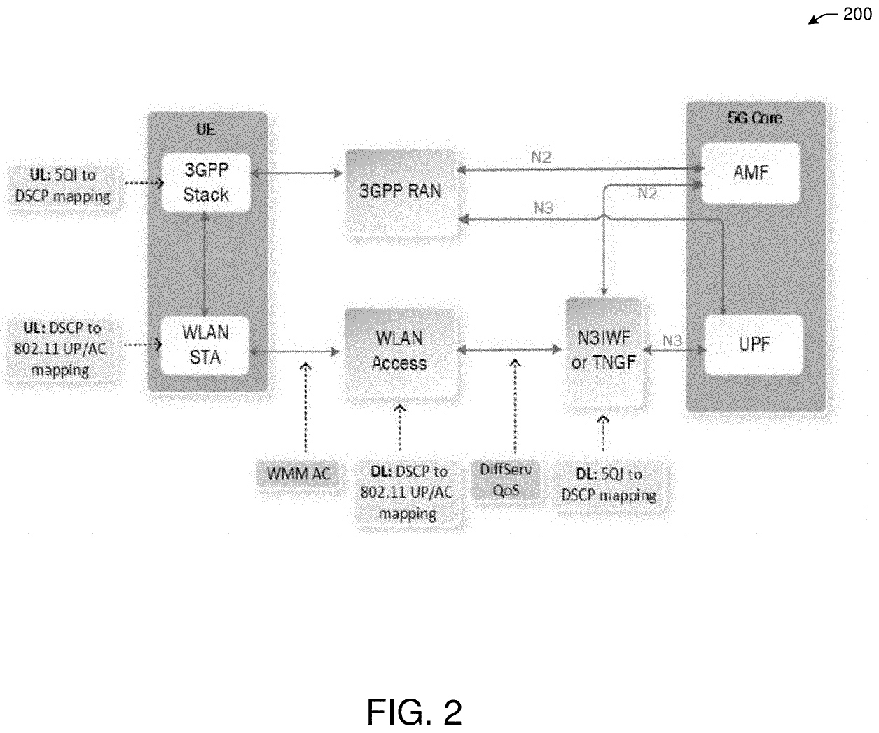

FIG. 2 illustrates an example end-to-end QoS model 300 for Wi-Fi communications in 5G systems, in accordance with one or more example embodiments of the present disclosure.

Referring to FIG. 2, the QoS model 300 uses an in-band DSCP marking to achieve QoS differentiation in a WLAN access. Because there are deployments in which the DSCP marking may not be preserved and reset by intermediate routers, there may be a need for QoS management that does not reply to in-band DSCP marking.

During the multi-access PDU session establishment or the single access PDU session establishment involving Wi-Fi access, the UE can initiate QoS management with the WLAN AP for 5G flows to be carried over Wi-Fi access in 5G Systems, without the need for in-band DSCP marking for QoS differentiation. Two options are possible for supporting QoS management within the WLAN access for 5G flows: (1) QoS Management with enhancements to 802.11 to an ADDTS Request/Response exchange (as shown in FIG. 3A), and (2) QoS Management with new MAC layer messages (as shown in FIG. 3B).

FIG. 3A illustrates an example QoS management process 300 for 5G user data flows using WLAN access, in accordance with one or more example embodiments of the present disclosure. The QoS management process 300 of FIG. 3A represents option (1) described with respect to FIG. 2 above (e.g., device-centric QoS management with WLAN during establishment of a MA-PDU session using an ADDTS request/response exchange).

Referring to FIG. 3A, a UE 302 may include a cellular stack 304 and a WLAN STA stack 306, and may communicate using a WLAN access 308, a N3IWF/TNGF 310, a gNB 312 (e.g., a logical 5G radio node), and a 5G core 314, including an access and mobility management function (AMF) 316, a session management function (SMF) 318, and a user plane function (UPF) 320. The UE 302 may send a PDU session establishment request to the AMF 316, and the AMF 316 may respond with a PDU session establishment accept message to the UE 102. The AMF 316 may send a N2 PDU session request to the N3IWF/TNGF 310, which may send an IKEv2 Create_Child_SA request (e.g., with a 5G_QoS_Info payload) to the UE 102. The 5G_QoS_Info payload may include 5G QoS characteristics and may specify a DSCP value to be used for marking the traffic sent over the IPSec child SA.

Still referring to FIG. 3A, a new process 328 for QoS management with WLAN for IPSec child SA may include the cellular stack 304 at block 330 mapping 5QI to DSCP. If a DSCP value is provided in the 5G_QOS_INFO payload, the UE 102 uses that for mapping 5G QoS (5QI) to a DSCP value for the IPsec SA. If a DSCP value is not provided, then the UE maps the 5QI to a DSCP value based on local configuration. The cellular stack 304 may send the 5QI to DSCP mapping 332 as well as the 5G QoS characteristics and parameters received in the 5G_QOS_INFO payload to the WLAN STA 306 on the device. The WLAN STA 306 at block 334 maps the DSCP value to 802.11 User Priority which gets mapped to 802.11 Access Categories as defined in the IEEE 802.11-2016 specification. Alternatively, the cellular stack 304 sends the 5G QoS characteristics and parameters to the WLAN STA 306 on the device, which then maps those to 802.11 UP based on local configuration defining mapping between 5G QoS (5QI) to 802.11 UP. To achieve QoS prioritization for 5G user data flows, the WLAN STA 306 can use an 802.11 Admission Control feature with ADDTS Request/Response messaging to negotiate QoS with WLAN AP 308 (e.g., ADDTS request 336, mapping 338, resource reservation for DL traffic flow 340, and ADDTS response 342). The WLAN STA 306 at block 334 maps some of the 5G QoS parameters to 802.11 TSPEC parameters and also includes User Priority requested for the traffic flow in TSPEC. In addition, following two new Elements are defined to be carried in the ADDTS Request message 336: (1) IPSec info element (e.g., providing parameters to identify an IPsec SA carrying DL 5G traffic, and used by the WLAN AP 308 to match DL 5G traffic for QoS prioritization); (2) 5G_TSPEC Element (e.g., providing 5G QoS parameters to the WLAN AP 308. Only some of the 5G QoS parameters can be directly mapped to TSPEC parameters. It is useful to provide other 5G QoS parameters to the WLAN AP 308 to enable resource allocation/reservation for 5G flows. This is an optional element which can be included to provide additional 5G QoS parameters to WLAN AP 308, besides the parameters sent as part of TSPEC.

In one or more embodiments, the WLAN STA 306 may send the ADDTS request 336 to the WLAN AP 308 for 5G DL traffic flow containing the following: (1) An IPSec Info Element with parameters to identify an IPSec child SA carrying DL 5G traffic; (2) a TSPEC Element specifying parameters derived from 5G QoS characteristics and parameters. The TSPEC Element may include a User Priority that was requested for the DL traffic on the IPSec child SA; and/or (3) A 5G_SPEC_Element to carry all the 5G QoS characteristics and parameters.

In one or more embodiments, the WLAN AP 308 may perform admission control for the 5G traffic flow carried over IPsec child SA (IPsec child SA traffic flow) based on the information received in the ADDTS Request message 336. If it can admit the traffic flow, the WLAN AP 308 maps (at 338) DL IPsec child SA traffic to the User Priority specified in the ADDTS Request 336. The WLAN AP 308 may also perform resource reservation at 340 for the IPsec child SA traffic flow based on 5G QoS parameters received in TSPEC and 5G_TSPEC elements. The WLAN AP 308 sends the ADDTS Response message 342 to the WLAN STA 306. The WLAN AP 308 can reject ADDTS Request message 336 if it cannot admit flow for the requested User Priority. The success/failure of traffic admission over the WLAN AP 308 is communicated to the cellular stack on the UE 102. If the ADDTS Request 336 was successful for the 5G IPsec child SA, then the UE 102 sends a successful response for the IKEv2 Create_Child_SA Request to N3IWF/TNGF 310. If the ADDTS Request 336 failed, then the UE 102 sends failure response for the IKEv2 Create_Child_SA Request and the child SA creation fails.

In one or more embodiments, the IPSec Info Element may be a new 802.11 element formatted as shown in Tables 2 and 3 for IPv4 and IPv6, respectively. The WLAN AP 308 can use a combination of SPI, Source IP Address and Destination IP Address to match DL traffic for QoS prioritization.

In one or more embodiments, the mapping of some 5G QoS characteristics and parameters to 802.11 TSPEC parameters is shown in Table 1. Using this mapping, the WLAN STA 306 generates TSPEC element from the 5G QoS characteristics and parameters received at the UE 102. Other required TSPEC parameters can be set based on local configured parameter values. The generated TSPEC element is sent in the ADDTS Request message 336 to the WLAN AP 308.

In one or more embodiments, the 5G_TSPEC Element may be a new 802.11 element with fields shown in Table 5.

FIG. 3B illustrates an example QoS management process 350 for 5G user data flows using WLAN access, in accordance with one or more example embodiments of the present disclosure. The QoS management process 305 of FIG. 3B represents option (2) described with respect to FIG. 2 above (e.g., device-centric QoS management with WLAN during establishment of a MA-PDU session using an a QoS negotiation request/response exchange).

Referring to FIG. 3B, a QoS management process 358 with WLAN for an IPSec child SA may include the cellular stack 304 mapping 5QI to DSCP at block 330. At block 332, the WLAN STA 306 may map DSCP to 802.11 UP/AC. The WLAN STA 306 may send a QoS negotiation request 360 to the WLAN AP 308, and the WLAN AP 308 may map DL IPSec traffic to 802.11 UP/AC. The WLAN AP 308 may send a QoS negotiation response 364 to the UE 102 to indicate whether the QoS negotiation request 360 was accepted or not.

Referring to FIG. 3B, a new pair of 802.11 MAC layer messages (QoS Negotiation Request 360/Response 364) are defined, which the WLAN STA 306 uses to negotiate QoS for IPsec child SA with the WLAN AP 308. The UE 102 maps the 5G QoS (5QI) to DSCP value and the WLAN STA 306 maps the DSCP to 802.11 UP/AC. Alternatively, the 5G QoS characteristics and parameters are sent to WLAN STA 306 on the device, which then maps those to 802.11 UP based on local configuration defining mapping between 5G QoS (5QI) to 802.11 UP. The WLAN STA 306 sends the QoS Negotiation Request message 360 with an IPsec Info element, Requested User Priority and 5G QoS info to the WLAN AP 308. The WLAN AP 308 performs admission control for the requested IPsec child SA and maps DL traffic for the child SA to requested UP/AC. The WLAN AP 308 may use 5G QoS info provided for resource allocation/reservation for the IPsec child SA traffic flow. The WLAN AP 308 sends a successful QoS Negotiation Response 364 message to the WLAN STA 306 if it can admit the requested UP for the IPsec child SA, otherwise it sends a failure response.

In one or more embodiments, the QoS management approach of FIGS. 3A and 3B for 5G user data flows can also be applied for the 5G NAS signaling data delivered over the signaling IPsec SA established between N3IWF/TNGF 310 and UE 302. FIG. 4A shows steps for the signaling IPsec SA establishment as part of the UE registration with the 5G core, and enhancements to that procedure to support QoS management for the signaling IPsec SA. Enabling QoS differentiation for signaling IPsec SA over WLAN can provide QoS benefit to meet requirements for different services and applications.

FIG. 4A illustrates an example QoS management process 400 for 5G user data flows using WLAN access, in accordance with one or more example embodiments of the present disclosure. The process 400 may represent option (1) described with respect to FIG. 2, but during registration rather than during MA-PDU session establishment.

Referring to FIG. 4A, the QoS management process 400 may include the UE 102, the cellular stack 304, the WLAN STA 306, the WLAN AP 308, the N3IWF/TNGF 310, and the 5G core 314 of FIG. 3A. During NAS registration, a QoS management process 403 with WLAN signaling for IPSec SA may occur. During the signaling IPsec SA establishment, a DSCP value can be sent to the UE 302 using a Notify Payload over IKE_AUTH messaging to mark NAS signaling data packets with that DSCP value 402 in the IP header. If UE 302 does not receive any DSCP value, UE 302 can be locally configured with a DSCP value to be used for the signaling IPsec SA. After UE registration is completed, the UE 302 triggers QoS negotiation with the WLAN AP 308 for the Signaling IPsec SA. First the WLAN STA 306 at block 404 maps the DSCP value 402 to 802.11 User Priority, which gets mapped to 802.11 Access Categories as defined in the IEEE 802.11-2016 specification. Alternatively, the WLAN STA 306 may be configured with a UP to be used for signaling IPsec SA. Next, the WLAN STA 306 sends an ADDTS Request 406 to the WLAN AP 308 to negotiate QoS prioritization for the signaling IPsec SA (e.g. AC_VO or AC_VI). The ADDTS Request 406 includes a TSPEC IE which is generated based on local configured parameter values for the 5G signaling data and includes 802.11 User Priority requested for the signaling IPsec SA. The ADDTS Request 406 also includes IPsec Info element to specify details for the signaling IPsec SA. The WLAN AP 308 at block 408 maps DL IPSec signaling to 802.11 UP/AC, at block 410 provides resource reservation, and then sends an ADDTS Response success message 412 to the WLAN STA 306 if it can admit the requested User Priority, resulting in QoS prioritization for NAS signaling data within WLAN. If the requested User Priority cannot be admitted, then a failure response is sent to the WLAN STA 306 in which case the NAS signaling data will get delivered using AC_BE (Best Effort) access category over WLAN. The QoS Management for 5G signaling IPsec SA can also be achieved using new 802.11 MAC layer messages as shown in FIG. 4B.

FIG. 4B illustrates an example QoS management process 450 for 5G user data flows using WLAN access, in accordance with one or more example embodiments of the present disclosure. The process 450 may represent option (2) described with respect to FIG. 2, but during registration rather than during MA-PDU session establishment.

During NAS registration, a QoS management process 452 with WLAN signaling for IPSec SA may occur. In this option, a the WLAN STA 306 sends a QoS Negotiation Request 454 to WLAN AP 308 to negotiate QoS prioritization for the signaling IPsec SA (e.g. AC_VO or AC_VI). The QoS Negotiation Request 454 includes 802.11 User Priority requested for the signaling IPsec SA and also includes IPsec Info element to specify details for the signaling IPsec SA. The WLAN AP 308 at block 456 maps DL IPSec signaling to 802.11 UP/AC, at block 458 performs resource reservation, and sends a successful QoS Negotiation Response message 460 to the WLAN STA 306 if it can admit the requested User Priority, resulting in QoS prioritization for NAS signaling data within the WLAN. If the requested User Priority cannot be admitted, then a failure response is sent to the WLAN STA 306.

Referring to FIGS. 3A-4B the following examples are provided:

Example 1 may include a 5G system integrating untrusted and/or trusted Wi-Fi access network with UE, NG-RAN, AMF, SMF, PCF, UPF, N3IWF, TNGF, Wi-Fi Access (with WLAN AP.

Example 2 may include a 5G system of example 1, where gateway functions for WLAN integration, the N3IWF and the TNGF, deliver a 5G_QOS_INFO payload to the UE as part of establishing an IPsec child security association (SA) during the PDU session establishment procedure, to carry 5G data flow(s) over the Wi-Fi access as described in 3GPP TS 23.502.

Example 3 may include a 5G system of example 1 and 2, where the UE initiates QoS management with the WLAN AP for 5G user data flows to be carried over Wi-Fi access during the PDU session establishment procedure, for either the multi-access PDU session or the single access PDU session involving Wi-Fi access.

Example 4 may include examples 1, 2 and 3, where the UE initiated QoS management with the WLAN AP for 5G user data flows is supported for both untrusted Wi-Fi access as well as trusted Wi-Fi access integration with 5G.

Example 5 may include examples 1, 2, 3 and 4, where the UE maps the 5G QoS characteristics identified by 5QI to a DSCP value based on local configuration, if no DSCP value is provided in the 5G_QOS_INFO payload for an IPsec child SA.

Example 6 may include examples 1 to 5, where the cellular stack on the UE sends 5QI to DSCP mapping and the 5G QoS characteristics received in the 5G_QOS_INFO payload to the WLAN STA on the device.

Example 7 may include examples 1 to 6, where the WLAN STA maps the DSCP value to 802.11 User Priority which gets mapped to 802.11 Access Categories as defined in IEEE 802.11-2016 specification.

Example 8 may include examples 1 to 7 and example 26, where the WLAN STA sends an 802.11 ADDTS Request message to WLAN AP which includes an 802.11 TSPEC IE, an IPsec Info element and a 5G_TSPEC element.

Example 9 may include examples 1 to 8, where the WLAN STA maps 5G QoS characteristics and parameters to 802.11 TSPEC parameters, sets other required TSPEC parameters based on local configured parameter values and includes 802.11 User Priority requested for the 5G flow in the TSPEC.

Example 10 may include examples 1 to 8, where the IPsec Info element includes parameters to identify an IPsec child SA tunnel carrying 5G traffic on the DL.

Example 11 may include example 10, where the IPsec Info element includes IPsec SPI (Security Parameter Index), IPsec Security Protocol, Source IP Address for DL data on the IPsec child SA and Destination IP address for the DL packet on the IPsec child SA.

Example 12 may include examples 1 to 8, where the 5G_TSPEC element includes 5G QoS characteristics and parameters fields defined in 3GPP TS 23.501.

Example 13 may include examples 1 to 12, where the WLAN AP performs admission control for the 5G traffic flow carried over IPsec child SA based on the information received in the ADDTS Request message.

Example 14 may include examples 1 to 13, where if the WLAN AP admits the IPsec child SA traffic flow, the WLAN AP maps DL IPsec SA traffic to the User Priority specified in the ADDTS Request and sends a success response to the STA. The WLAN AP uses a combination of SPI, Source IP Address and Destination IP Address to match DL traffic for QoS prioritization.

Example 15 may include examples 1 to 14, where the WLAN AP may also do resource reservation for the IPsec child SA traffic flow based on 5G QoS parameters received in TSPEC and 5G_TSPEC elements.

Example 16 may include examples 1 to 15, where the WLAN AP sends a failure response to the STA if it cannot admit the IPsec child SA traffic flow for the requested User Priority.

Example 17 may include examples 1 to 15, where if the ADDTS Request was successful for the IPsec child SA traffic flow, then the UE sends a successful response for the IKEv2 Create_Child_SA Request to gateway function N3IWF or TNGF.

Example 18 may include examples 1 to 16, where if the ADDTS Request failed, then the UE sends a failure response for the IKEv2 Create_Child_SA Request to gateway function N3IWF or TNGF, and the IPsec child SA creation fails.

Example 19 may include example 1, where during the UE registration with the 5G Core a DSCP value can be sent to the UE using a Notify Payload over IKE_AUTH messaging when establishing the signaling IPsec SA over WLAN access for NAS data transport.

Example 20 may include examples 1 and 19, where if UE does not receive any DSCP value, the UE can be locally configured with a DSCP value to be used for the signaling IPsec SA. Alternatively, the WLAN STA may be configured with an 802.11 User Priority value to be used for signaling IPsec SA.

Example 21 may include examples 1, 19 and 20, where the WLAN STA triggers QoS negotiation with the WLAN AP for the signaling IPsec SA after UE registration is completed with the 5G core, by sending an ADDTS Request message.

Example 22 may include example 1 and examples 19 to 21, where the WLAN STA includes a TSPEC IE, and an IPsec Info element in the ADDTS Request message.

Example 23 may include example 1 and examples 19 to 22, where the TSPEC IE is generated based on local configured parameter values for the 5G signaling traffic and includes 802.11 User Priority requested for the signaling IPsec SA.

Example 24 may include example 1 and examples 19 to 22, where the IPsec Info element includes parameters to identify the signaling IPsec SA tunnel carrying NAS signaling data.

Example 25 may include example 1 and examples 19 to 22, where the WLAN AP sends an ADDTS Response success message to the STA if it can admit the requested User Priority for the signaling IPsec SA and sends a failure response if it cannot admit the requested User Priority for the signaling IPsec SA.

Example 26 may include examples 1 to 6, where the cellular stack sends the 5G QoS characteristics and parameters to the WLAN STA on the device, which then maps those to 802.11 UP based on local configuration defining mapping between 5G QoS (5QI) to 802.11 User Priority/Access Category.

Example 27 may include examples 1 to 7 and example 26, where the WLAN STA sends a QoS Negotiation Request message with IPsec Info element, Requested User Priority and 5G QoS info to the WLAN AP. The WLAN AP sends a successful QoS Negotiation Response message to the WLAN STA if it can admit the requested UP for the IPsec child SA, else it sends a failure response.

Example 28 may include examples 1 to 21, where the WLAN STA sends the QoS Negotiation Request to WLAN AP to negotiate QoS prioritization for the signaling IPsec SA. The request includes 802.11 User Priority requested for the signaling IPsec SA and also includes IPsec Info element to specify details for the signaling IPsec SA.

Example 29 may include examples 1 to 21 and example 28, where The WLAN AP sends a successful QoS Negotiation Response message to the STA if it can admit the requested User Priority, resulting in QoS prioritization for NAS signaling data within WLAN. If the requested User Priority cannot be admitted, then a failure response is sent to the STA.

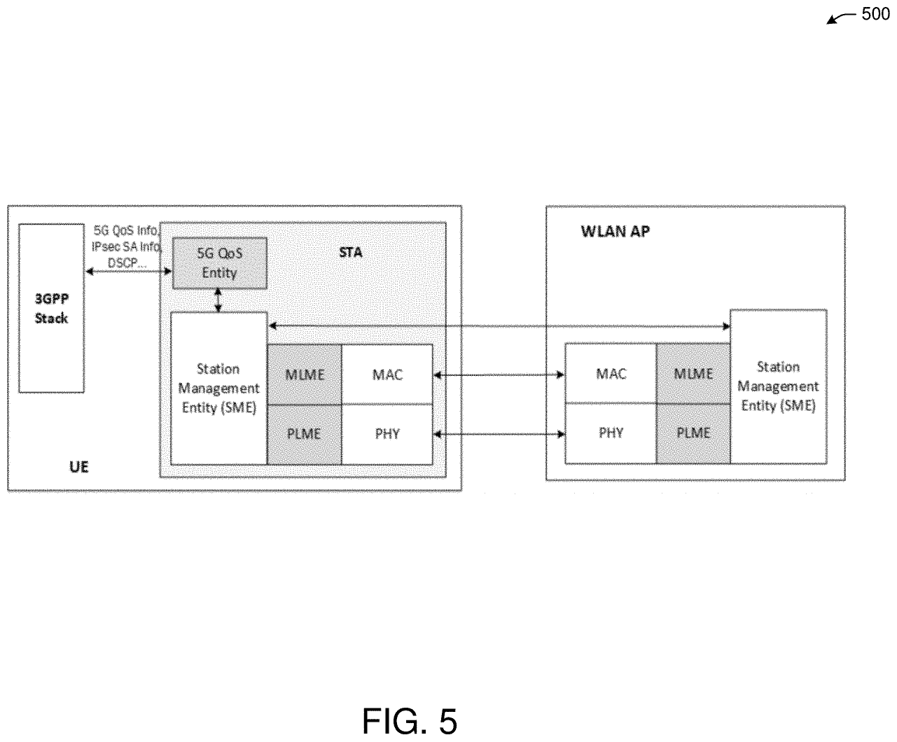

FIG. 5 illustrates an example WLAN reference architecture 500 for network-centric QoS management for 5G process flows or signaling, in accordance with one or more example embodiments of the present disclosure.

The WLAN reference architecture 500 is a device-centric QoS management model that also is applicable to Wi-Fi-only devices with 3GPP NAS functionality for connecting to a 5G core over untrusted or trusted WLAN access. The 3GPP stack on such devices refers to 3GPP NAS+NWu/NWt interface functionality as defined in the 3GPP specifications. There are two options for device-centric QoS negotiation and to establish QoS traffic streams (TSs) for carrying 5G traffic over IPSec SAs within WLAN access: (1) QoS negotiation with enhancements to 802.11 QoS management frames, and (2) QoS negotiation with new QoS management messages.

FIG. 6A illustrates an example WLAN station (STA)-initiated QoS negotiation 600 for 5G traffic using 802.11 QoS management frames, in accordance with one or more example embodiments of the present disclosure. FIG. 6A represents option 1 as described with respect to FIG. 5, and represents an STA-initiated QoS negotiation and QoS traffic Stream (TS) Setup for 5G traffic flows with WLAN access.

Referring to FIG. 6A, a UE 602 may include a cellular stack 604, a STA 606 with a 5G QoS entity 608, an SME 610, and a MAC 612. An AP 620 may include a MAC 622 and an SME 624. The 5G QoS Entity 608 receives 5G QoS related information 630 from the cellular stack 604 on the UE 602 as described above. The 5G QoS related information 630 includes 5G QoS flow characteristics and parameters, IPsec SA (security association) info to identify IPsec child SAs and signaling SA established over WLAN to carry 5G traffic and any assigned DSCP value for IPsec SAs. After receiving 5G QoS related information 630, the 5G QoS Entity 608 at block 632 maps 5G QoS to 802.11 TPSec and UP, at block 634 generates an 802.11 TCLAS for IPSec SAs, and at block 636 creates a 5G_TPSEC. The 5G QoS Entity 608 triggers the QoS traffic stream setup procedure 638 by sending a QoS TS Setup Request 637 to the local SME 610. This message includes one or more TSPEC element (with QoS parameters for UL and DL TS), TCLAS elements (for IPsec SAs carrying 5G traffic and associated 802.11 User Priority) and 5G_TSPEC element (providing 5G QoS flow characteristics and parameters). Two separate TCLAS elements are included to provide filtering information for identifying IPsec SAs carrying 5G traffic in UL and DL.

Still referring to FIG. 6A, the SME 610 starts the QoS Traffic Stream (TS) negotiation procedure 638 with the AP by initiating a MLME-ADDTS Request primitive 640 with the MAC layer 622, which starts the QoS negotiation by exchanging ADDTS Request 642/Response 644 with the AP 620 to setup the UL and DL traffic streams as per TSPEC and TCLAS parameters. Multiple ADDTS Request/Response exchanges occur with the AP 620 to setup QoS TS in both UL and DL direction. The ADDTS Request message 640 includes the TSPEC element and the TCLAS element specifying traffic filters and User Priority for the corresponding IPsec SA (UL or DL SA). The TCLAS element might not be included for IPsec SA carrying UL traffic, in which case the User Priority is included as part of the TSPEC element. The ADDTS Request 640 also includes the 5G_TSPEC element received from the 5G QoS Entity, which provides detailed 5G QoS flow characteristics and parameters which can be used by the AP 620 along with TSPEC for resource allocation/reservation for 5G flows.

Still referring to FIG. 6A, the AP 620 follows the procedure defined in the 802.11 specification for TS setup based on received TSPEC and TCLAS elements and additionally takes into account 5G_TSPEC element received from the STA 606. If the QoS TS setup completes successfully on the AP 620, it sends a success indication to the STA in the ADDTS Response message 646. If the QoS TS setup fails on the AP 620, it sends a failure indication to the STA in the ADDTS Response message 646. The SME 610 sends a MLME-ADDTS confirm primitive 648 to the SME 610, and sends a QoS TS Setup Response message 650 to the 5G QoS Entity 608 indicating the success/failure outcome of QoS negotiation for the IPsec SAs carrying 5G traffic.

FIG. 6B illustrates an example WLAN STA-initiated QoS negotiation 650 for 5G traffic using 802.11 QoS management messages, in accordance with one or more example embodiments of the present disclosure. FIG. 6B represents option 2 as described with respect to FIG. 5, and represents an STA-initiated QoS negotiation and QoS traffic Stream (TS) Setup for 5G traffic flows with WLAN access.

FIG. 6B shows a WLAN STA initiated QoS negotiation procedure 662 for 5G traffic to setup QoS traffic streams (TS) with new set of QoS management messages defined. In this option, new set of QoS Negotiation Request/Response messages are defined to initiate QoS traffic stream setup from the WLAN STA 606. The SME sends a MLME-QoS Request 664 to the MAC 612, which sends a QoS Negotiation Request 666 to the MAC 622 of the AP 620. The QoS Negotiation Request 666 includes same set of parameters as the ADDTS Request 640 as described above with respect to FIG. 6A, which includes TSPEC, TCLAS and 5G_TSPEC elements. Multiple rounds of QoS Negotiation Request/Response exchange could happen to establish QoS traffic stream for UL and DL IPsec SA.

Still referring to FIG. 6B, the AP 620 follows the procedure defined in the 802.11 specification for TS setup based on received TSPEC and TCLAS elements and additionally takes into account 5G_TSPEC element received from the STA 606. The MAC 622 sends an MLME-QoS indication 668 to the SME 624, which responds with an MLME-QoS response 670. If the QoS TS setup is successful on the AP 620, it sends a success indication to the STA 606 in a QoS Negotiation Response message 672. If the QoS TS setup fails on the AP 620, it sends a failure indication to the STA 606 in the QoS Negotiation Response message 672. The SME 610 sends an MLME QoS confirm message to the SME 610, and sends a QoS TS Setup Response message 676 to the 5G QoS Entity 608 indicating the success/failure outcome of QoS negotiation for the IPsec SAs carrying 5G traffic. After successful QoS negotiation and traffic streams setup for IPsec SAs: (1) The WLAN AP 620 will identify the DL 5G traffic carried over IPsec child SA or IPsec signaling SA based on TCLAS traffic filters (SPI, destination IP address and security protocol ID) for the downlink IPsec SA and will map the DL 5G traffic to the User Priority as specified in the TCLAS or TSPEC element for the associated traffic stream; and/or (2) the WLAN STA 6-6 will identify the UL 5G traffic carried over IPsec child SA or IPsec signaling SA based on TCLAS traffic filters (SPI, destination IP address and security protocol ID) for the uplink IPsec SA and will map the UL 5G traffic to the User Priority as specified in the TCLAS or TSPEC element for the associated traffic stream.

Referring to FIGS. 6A-6B the following examples are provided:

Example 1 may include a WLAN system integrated with 5G core via TNGF or N3IWF gateway function with UE supporting cellular and Wi-Fi capabilities, Wi-Fi Access network (with WLAN AP and Wireless LAN Controller) and other essential elements as described in 3GPP TS 23.501 and IEEE 802.11-2016 specification.

Example 2 may include a WLAN system of example 1, where the UE may be a Wi-Fi only device with 3GPP NAS functionality and NWu and/or NWt interface functionality for connecting to 5G Core over untrusted or trusted WLAN access as defined in 3GPP specs TS 23.501, TS 23.502 and TS 24.502.

Example 3 may include a WLAN system of examples 1 or 2, where a higher layer entity called ‘5G QoS Entity’ is co-located within the WLAN STA on the UE to provide support for device centric QoS management for 5G traffic.

Example 4 may include example 3, where the 5G QoS Entity receives 5G QoS related information from the 3GPP cellular stack for 5G user data flows and 5G signaling.

Example 5 may include example 4, where the 5G QoS related information includes 5G QoS flow characteristics and parameters, IPsec SA (security association) info to identify IPsec child SAs and/or IPsec signaling SA established over WLAN access to carry 5G traffic and any assigned DSCP value for IPsec SAs.

Example 6 may include example 5, where the IPsec SA information includes information to identify IPsec SA in each direction for UL and DL traffic. For each IPsec SA the SPI (Security Parameter Index), the destination IP address and security protocol ID information is included to uniquely identify the IPsec SA as defined in RFC 2401.

Example 7 may include examples 3 to 6, where the 5G QoS Entity can provide device centric QoS management for 5G traffic for both trusted and untrusted WLAN access integrated within a 5G system.

Example 8 may include examples 3 to 7, where the 5G QoS Entity on the WLAN STA initiates QoS negotiation for the 5G traffic with the local SME after it receives 5G QoS related information from 3GPP cellular stack on the UE.

Example 9 may include examples 3 to 8, where the 5G QoS Entity maps the 5G QoS flow characteristics and parameters to 802.11 QoS Traffic Specification (TSPEC) and 802.11 User Priority.

Example 10 may include examples 3 to 9, where the 5G QoS Entity can take into account DSCP value received from 3GPP cellular stack to determine mapping of 5G QoS to 802.11 User Priority.

Example 11 may include example 9, where the TSPEC can specify desired QoS parameters for traffic streams (TS) in both UL and DL direction if same QoS parameters apply in both directions, or separate TSPEC can be generated to specify QoS parameters for traffic streams in UL and DL direction.

Example 12 may include examples 3 to 11, where the 5G QoS Entity creates two separate 802.11 Traffic Classification (TCLAS) elements, one each for UL and DL traffic, from the IPsec SA information received from the 3GPP cellular stack to indicate traffic filters (SPI, destination IP address and security protocol ID) for the IPsec SAs carrying 5G traffic.

Example 13 may include examples 3 to 12, where the TCLAS element includes the 802.11 User Priority for the corresponding IPsec SA specified in that TCLAS.

Example 14 may include examples 3 to 13, where the 5G QoS Entity generates a 5G_TSPEC element from the 5G QoS flow characteristics and parameters received from the 3GPP cellular stack.

Example 15 may include examples 3 to 14, where the 5G QoS Entity on the STA triggers the QoS traffic stream setup procedure by sending a QoS TS Setup Request to the local SME.

Example 16 may include examples 3 to 15, where the QoS TS Setup Request includes one or more TSPEC element (with QoS parameters for UL and DL TS), TCLAS elements (for IPsec SAs carrying 5G traffic and associated 802.11 User Priority) and 5G_TSPEC element (providing 5G QoS flow characteristics and parameters). Two separate TCLAS elements are included to provide filtering information for identifying IPsec SAs carrying 5G traffic in UL and DL.

Example 17 may include examples 2 to 16, where the SME on WLAN STA initiates an MLMEADDTS Request primitive or an MLME-QoS Negotiation Request primitive with the MAC layer with TSPEC, TCLAS and 5G_TSPEC elements, populated based on parameters received from the 5G QoS entity.

Example 18 may include examples 3 to 17, where the MAC layer on WLAN STA initiates QoS TS setup by sending an ADDTS Request or a QoS Negotiation Request to the WLAN AP with TSPEC, TCLAS (with traffic filters for IPsec SA and User Priority) and 5G_TSPEC elements.

Example 19 may include examples 3 to 18, where the TCLAS element may not be included for the IPsec SA carrying UL traffic, in which case the User Priority is included as part of the TSPEC element.

Example 20 may include examples 3 to 19, where the WLAN AP may use the TSPEC parameters and the 5G QoS flow characteristics and parameters received in the 5G_TSPEC element for resource allocation/reservation for 5G flows.

Example 21 may include examples 3 to 20, where multiple ADDTS Request/Response or multiple QoS Negotiation Request/Response exchange happens between STA and the AP to setup QoS TS for IPsec SAs in both UL and DL direction.

Example 22 may include examples 3 to 21, where the QoS TS setup is successful on the AP, the WLAN AP sends a success indication to the STA in the ADDTS Response or the QoS Negotiation Response message.

Example 23 may include examples 3 to 22, where the QoS TS setup fails on the AP, the WLAN AP sends a failure indication to the STA in the ADDTS Response or the QoS Negotiation Response message.

Example 24 may include examples 3 to 23, where the SME on the STA sends a QoS TS Setup Response message to the 5G QoS Entity indicating the success or failure outcome of QoS negotiation for the IPsec SAs carrying 5G traffic.

Example 25 may include example 22, where after successful QoS traffic stream setup for IPsec SAs carrying 5G traffic, the WLAN AP will identify the DL 5G traffic carried over IPsec child SA or IPsec signaling SA based on TCLAS traffic filters (SPI, destination IP address and security protocol ID) for the downlink IPsec SA and will map the DL 5G traffic to the User Priority as specified in the TCLAS or TSPEC element for the associated traffic stream.

Example 31 may include example 22, where after successful QoS traffic stream setup for IPsec SAs carrying 5G traffic, the WLAN STA will identify the UL 5G traffic carried over IPsec child SA or IPsec signaling SA based on TCLAS traffic filters (SPI, destination IP address and security protocol ID) for the uplink IPsec SA and will map the UL 5G traffic to the User Priority as specified in the TCLAS or TSPEC element for the associated traffic stream.

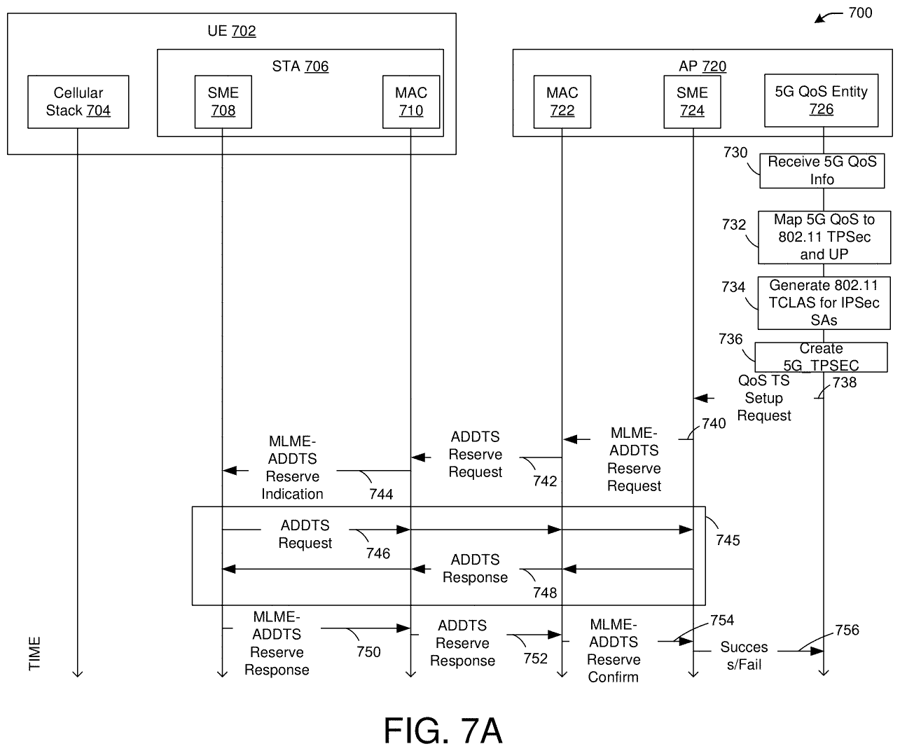

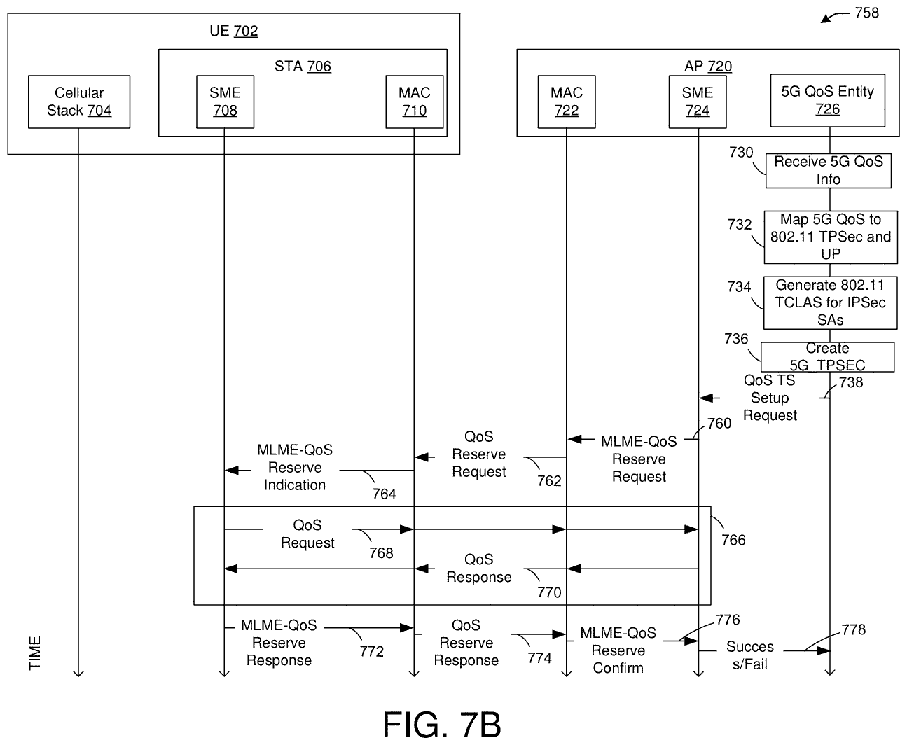

FIG. 7A illustrates an example WLAN access point (AP)-initiated QoS negotiation 700 for 5G traffic using 802.11 QoS management frames, in accordance with one or more example embodiments of the present disclosure. FIG. 7A represents option 1 as described with respect to FIG. 5, and represents an AP-initiated QoS negotiation and QoS traffic Stream (TS) Setup for 5G traffic flows with WLAN access.

Referring to FIG. 7A, the AP-initiated QoS negotiation 700 may include a UE 702 with a cellular stack 704, a STA 706 with an SME 708 and a MAC 701, and an AP 720 may include a MAC 722, an SME 724, and a 5G QoS Entity 726. At block 730, the 5G QoS Entity 726 may receive 5G QoS information (e.g., from TNGF). At block 732, the 5G QoS Entity 726 may map the 5G QoS to 802.11 TSPEC and UP. At block 734, the 5G QoS Entity 726 may generate an 802.11 TCLAS for IPSec SAs. At block 736, the 5G QoS Entity 726 may create a 5G_TSPEC. At block 738, the 5G QoS Entity 726 may determine a STA MAC address from the STA IP address. The 5G QoS Entity 726 triggers the AP-initiated TS Setup procedure by sending a QoS TS Setup Request 738 to the SME 724. This message includes one or more TSPEC elements (with QoS parameters for UL and DL TS), TCLAS elements (for identifying IPSec SAs carrying 5G traffic and associated 802.11 User Priority), 5G_TSPEC element (providing 5G QoS flow characteristics and parameters), Higher Layer Stream ID (HLStreamID, set to PDU Session ID for 5G) and UE WLAN STA MAC Address. Two separate TCLAS elements are included to provide filtering information for identifying IPsec SAs carrying 5G traffic in UL and DL.

Still referring to FIG. 7A, after receiving the QoS TS Setup Request 738, the SME 724 initiates an MLME-ADDTS Reserve Request 740 primitive with the MAC layer with parameters, populated based on parameters (e.g., TSPEC, TCLAS, 5G_TSPEC, HLStream ID for 5G, PeerSTAAddress) received from the 5G QoS entity 726. This primitive includes new parameters PeerSTAAddress, TCLAS element, and 5G_TSPEC element, besides the parameters specified in 802.11-2016. More than one TSPEC element can be included to specify different set of QoS parameters for traffic streams in UL and DL direction. The MAC layer 722 initiates QoS TS setup by sending an ADDTS Reserve Request 740 (as an Action frame) to the non-AP STA 706 specified by the PeerSTAAddress in the MLME-ADDTS Reserve Request 740. The ADDTS Reserve Request 742 sent to the non-AP STA 706 includes two new parameters TCLAS and 5G_TSPEC as highlighted in Table 6 below, besides the parameters specified in 802.11 specification at Table 9-356.

TABLE 6
ADDTS Reserve Request
Action Field Format:

| Order | Information |
|---|---|
| 1 | Category |
| 2 | QoS Action |
| 3 | TSPEC |
| 4 | Schedule |
| 5 | Higher Layer Stream ID |
| 6 | TCLAS |
| 7 | 5G_TSPEC |

Still referring to FIG. 7A, after receiving the ADDTS Reserve Request 742, the non-AP STA 706 generates the MLME-ADDTS Reserve Indication primitive 744, which notifies the SME 708 of the receipt of the ADDTS Reserve Request 742 from the AP 720. The SME 708 starts the QoS Traffic Stream (TS) negotiation procedure 745 with the AP 720 for the TSPEC QoS parameters and TCLAS traffic filters received in the MLME-ADDTS Reserve Indication primitive 744. The QoS negotiation is performed by exchanging ADDTS Request 746/Response 748 with the AP 720 to setup the UL and DL traffic streams as per TSPEC parameters. Multiple ADDTS Request/Response exchange may occur with the AP 720 to setup QoS TS in both UL and DL directions. The ADDTS Request message 746 includes the TSPEC element as received in the ADDTS Reserve Request 742 and the TCLAS element specifying traffic filters and User Priority for the corresponding IPsec SA (UL or DL SA). The TCLAS element might not be included for IPsec SA carrying UL traffic, in which case the User Priority is included as part of the TSPEC element. The ADDTS Request 746 also echoes the 5G_TSPEC element received from the AP 720, which provides detailed 5G QoS flow characteristics and parameters which can be used by the AP 720 for resource allocation/reservation for 5G flows. The Higher Layer Stream ID for 5G (which is set to PDU Session ID) is included in each of the ADDTS Request 746/Response 748 exchange. The ADDTS Response 748 frame includes set of parameters as defined in the 802.11 specification. If the QoS negotiation and TS setup is successful for both UL and DL IPsec SAs indicated by success status code in the ADDTS Response frame 748, the non-AP STA 706 sends an ADDTS Reserve Response primitive 750 to the MAC 710 and an ADDTS Reserve Response frame 752 to the AP 720 with the Higher Layer Stream ID for 5G and indicating success status code for the QoS negotiation. The MAC 722 sends an MLME ADDTS reserve confirm primitive 754 to the SME 724. If the TS setup fails, the non-AP STA 706 sends an ADDTS Reserve Response frame 752 to the AP 720 with the Higher Layer Stream ID for 5G and indicating a failure status code for the QoS negotiation. The SME 724 sends a QoS TS Setup Response message 756 to the 5G QoS Entity 726 indicating the success/failure outcome of QoS negotiation for the IPsec SAs carrying 5G traffic.

FIG. 7B illustrates an example WLAN access point (AP)-initiated QoS negotiation 758 for 5G traffic using 802.11 QoS management frames, in accordance with one or more example embodiments of the present disclosure. FIG. 7A represents option 2 as described with respect to FIG. 5, and represents an AP-initiated QoS negotiation and QoS traffic Stream (TS) Setup for 5G traffic flows with WLAN access.

FIG. 7B, shows AP initiated QoS negotiation procedure for 5G traffic to setup QoS traffic streams (TS) with new set of QoS management messages defined. In this option, new set of QoS Reservation Request/Response messages are defined to trigger AP-initiated QoS negotiation for IPsec SAs carrying 5G traffic. After receiving the QoS TS Setup Request 738, the SME 724 initiates an MLME-QoS Reserve Request 760 primitive with the MAC layer 722 with parameters. The MAC 722 may send a QoS Reservation Request 762 to the STA 706. The QoS Reservation Request 762 carries same set of QoS related parameters as the ADDTS Reserve Request frame 742 of FIG. 7A, which includes TSPEC, TCLAS, 5G_TSPEC and Higher Layer Stream ID for 5G. The MAC 710 sends an MLME-QoS Reserve indication primitive 764 to the SME 708, and the QoS traffic stream setup 766 is initiated from the non-AP STA 706 with new set of QoS Negotiation Request 768/Response 770 MAC layer messages. The QoS Negotiation Request 768 carries same set of parameters as the ADDTS Request 742 of FIG. 7A, which includes TSPEC, TCLAS, 5G_TSPEC and the Higher Layer Stream ID for 5G. Multiple rounds of QoS Negotiation Request 768/Response 770 exchange could happen to establish QoS traffic stream for UL and DL IPsec SA. If the QoS negotiation and traffic stream setup 766 is successful for both UL and DL IPsec SAs indicated by success status code in the QoS Negotiation Response frame 770, the non-AP STA 706 sends a QoS Reservation Response primitive 772 to the MAC 710 and sends a QoS Reservation Response frame 774 to the AP 720 with the Higher Layer Stream ID for 5G and indicating success status code for the QoS negotiation. If the TS setup negotiation fails, the non-AP STA 706 sends a QoS Reservation Response frame 774 to the AP 720 with the Higher Layer Stream ID for 5G and indicating a failure status code for the QoS negotiation. The MAC 722 sends an MLME-QoS reserve confirm primitive to the SME 724, which sends a success/failure confirmation 778 to the 5G QoS entity 726 indicating whether the negotiation succeeded or failed.

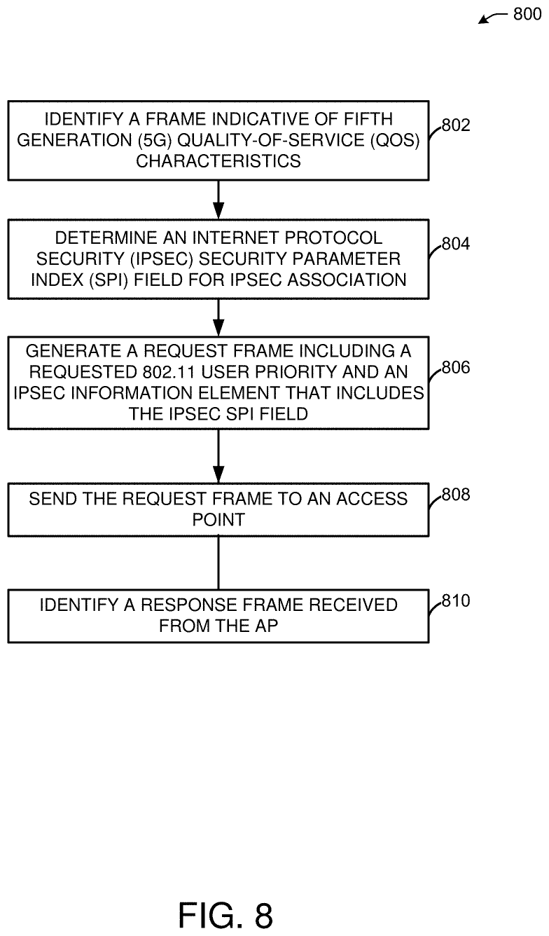

FIG. 8 illustrates a flow diagram of illustrative process 800 for QoS using 5G communications, in accordance with one or more example embodiments of the present disclosure.

At block 802, a device (or apparatus, e.g., the UE 302 of FIGS. 3A-4B) may identify a frame (e.g., the IKEv2 Create_Child_SA Request of FIGS. 3A-3B, the IKE_AUTH of FIGS. 4A-4B) received (e.g., using the cellular stack 304 of FIGS. 3A-4B) from a second device (e.g., the N3IWF/TNGF 310 of FIGS. 3A-4B). The frame may be part of a device registration process (e.g., FIGS. 4A-4B) or an MA-PDU session establishment. The frame may include the 5G QoS parameters or a DSCP value that can be mapped to the 5G QoS parameters.

At block 804, the device may determine an IPSec SPI field for IPSec association. The IPSec SPI field may be set to the SPI for the IPSec SA, referring to either a first value of the SPI for the IPSec child SA, or a second SPI value for the signaling IPSec SA established between the second device and the device.

At block 806, the device may generate a request frame, either an ADDTS frame (e.g., FIGS. 3A-3B) or a QoS Negotiation frame (e.g., (FIGS. 4A-4B). The request frame may include a requested 802.11 user priority and an IPSec information element that includes the IPSec SPI field of block 804.

At block 808, the device may send the request frame to an AP (e.g., the WLAN AP 308 of FIGS. 3A-4B). The AP may determine whether it can admit the request or must reject the request, and may send a response accordingly. At block 810, the device may receive the response from the AP.

It is understood that the above descriptions are for purposes of illustration and are not meant to be limiting.

FIG. 9 shows a functional diagram of an exemplary communication station 900, in accordance with one or more example embodiments of the present disclosure. In one embodiment, FIG. 9 illustrates a functional block diagram of a communication station that may be suitable for use as any of the devices in FIG. 1, in accordance with some embodiments. The communication station 900 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 900 may include communications circuitry 902 and a transceiver 910 for transmitting and receiving signals to and from other communication stations using one or more antennas 901. The communications circuitry 902 may include circuitry that can operate the physical layer (PHY) communications and/or medium access control (MAC) communications for controlling access to the wireless medium, and/or any other communications layers for transmitting and receiving signals. The communication station 900 may also include processing circuitry 906 and memory 908 arranged to perform the operations described herein. In some embodiments, the communications circuitry 902 and the processing circuitry 906 may be configured to perform operations detailed in the above figures, diagrams, and flows.

In accordance with some embodiments, the communications circuitry 902 may be arranged to contend for a wireless medium and configure frames or packets for communicating over the wireless medium. The communications circuitry 902 may be arranged to transmit and receive signals. The communications circuitry 902 may also include circuitry for modulation/demodulation, upconversion/downconversion, filtering, amplification, etc. In some embodiments, the processing circuitry 906 of the communication station 900 may include one or more processors. In other embodiments, two or more antennas 901 may be coupled to the communications circuitry 902 arranged for sending and receiving signals. The memory 908 may store information for configuring the processing circuitry 906 to perform operations for configuring and transmitting message frames and performing the various operations described herein. The memory 908 may include any type of memory, including non-transitory memory, for storing information in a form readable by a machine (e.g., a computer). For example, the memory 908 may include a computer-readable storage device, read-only memory (ROM), random-access memory (RAM), magnetic disk storage media, optical storage media, flash-memory devices and other storage devices and media.

In some embodiments, the communication station 900 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 900 may include one or more antennas 901. The antennas 901 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 900 may include one or more of a keyboard, a display, a non-volatile memory port, multiple antennas, a graphics processor, an application processor, speakers, and other mobile device elements. The display may be an LCD screen including a touch screen.

Although the communication station 900 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 900 may include one or more processors and may be configured with instructions stored on a computer-readable storage device.

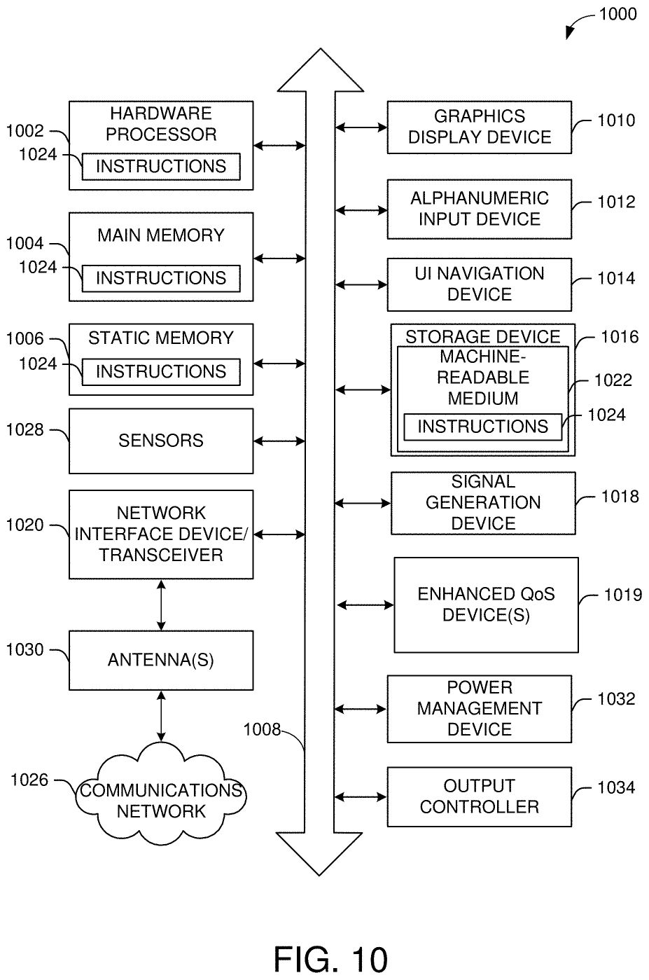

FIG. 10 illustrates a block diagram of an example of a machine 1000 or system upon which any one or more of the techniques (e.g., methodologies) discussed herein may be performed. In other embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environments. The machine 1000 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a power management device 1032, a graphics display device 1010, an alphanumeric input device 1012 (e.g., a keyboard), and a user interface (UI) navigation device 1014 (e.g., a mouse). In an example, the graphics display device 1010, alphanumeric input device 1012, and UI navigation device 1014 may be a touch screen display. The machine 1000 may additionally include a storage device (i.e., drive unit) 1016, a signal generation device 1018 (e.g., a speaker), a QoS device 1019, a network interface device/transceiver 1020 coupled to antenna(s) 1030, and one or more sensors 1028, such as a global positioning system (GPS) sensor, a compass, an accelerometer, or other sensor. The machine 1000 may include an output controller 1034, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1002 for generation and processing of the baseband signals and for controlling operations of the main memory 1004, the storage device 1016, and/or the QoS device 1019. The baseband processor may be provided on a single radio card, a single chip, or an integrated circuit (IC).

The storage device 1116 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1016 may constitute machine-readable media.

The QoS device 1019 may carry out or perform any of the operations and processes (e.g., process 800) described and shown above.

It is understood that the above are only a subset of what the QoS device 1019 may be configured to perform and that other functions included throughout this disclosure may also be performed by the QoS device 1019.

While the machine-readable medium 1022 is illustrated as a single medium, the term “machine-readable medium” may include a single medium or multiple media (e.g., a centralized or distributed database, and/or associated caches and servers) configured to store the one or more instructions 1024.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device/transceiver 1020 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1020 may include one or more physical jacks (e.g., Ethernet, coaxial, or phone jacks) or one or more antennas to connect to the communications network 1026. In an example, the network interface device/transceiver 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1000 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

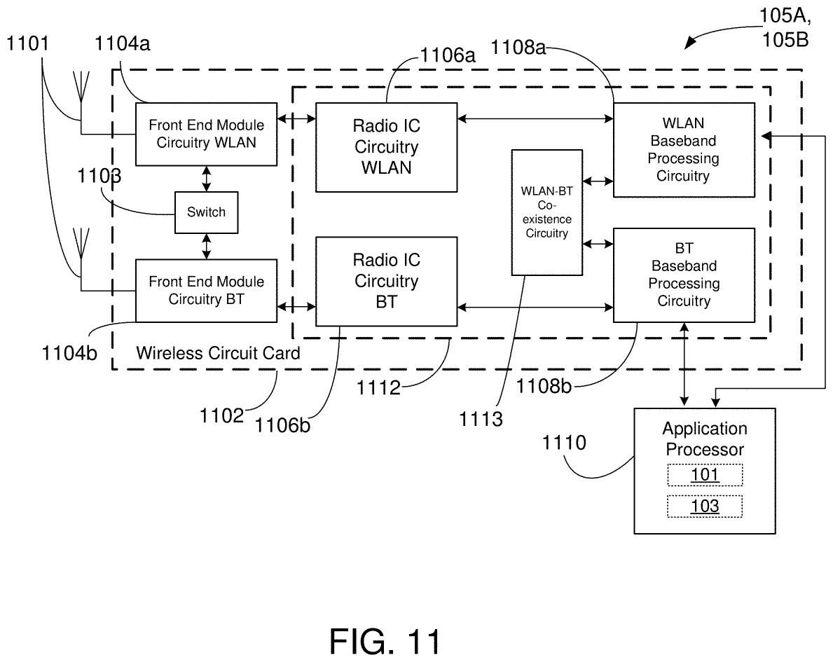

FIG. 11 is a block diagram of a radio architecture 105A, 105B in accordance with some embodiments that may be implemented in any one of the example devices of FIG. 1. Radio architecture 105A, 105B may include radio front-end module (FEM) circuitry 1104a-b, radio IC circuitry 1106a-b and baseband processing circuitry 1108a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1104a-b may include a WLAN or Wi-Fi FEM circuitry 1104a and a Bluetooth (BT) FEM circuitry 1104b. The WLAN FEM circuitry 1104a may include a receive signal path comprising circuitry configured to operate on WLAN RF signals received from one or more antennas 1101, to amplify the received signals and to provide the amplified versions of the received signals to the WLAN radio IC circuitry 1106a for further processing. The BT FEM circuitry 1104b may include a receive signal path which may include circuitry configured to operate on BT RF signals received from one or more antennas 1101, to amplify the received signals and to provide the amplified versions of the received signals to the BT radio IC circuitry 1106b for further processing. FEM circuitry 1104a may also include a transmit signal path which may include circuitry configured to amplify WLAN signals provided by the radio IC circuitry 1106a for wireless transmission by one or more of the antennas 1101. In addition, FEM circuitry 1104b may also include a transmit signal path which may include circuitry configured to amplify BT signals provided by the radio IC circuitry 1106b for wireless transmission by the one or more antennas. In the embodiment of FIG. 11, although FEM 1104a and FEM 1104b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1106a-b as shown may include WLAN radio IC circuitry 1106a and BT radio IC circuitry 1106b. The WLAN radio IC circuitry 1106a may include a receive signal path which may include circuitry to down-convert WLAN RF signals received from the FEM circuitry 1104a and provide baseband signals to WLAN baseband processing circuitry 1108a. BT radio IC circuitry 1106b may in turn include a receive signal path which may include circuitry to down-convert BT RF signals received from the FEM circuitry 1104b and provide baseband signals to BT baseband processing circuitry 1108b. WLAN radio IC circuitry 1106a may also include a transmit signal path which may include circuitry to up-convert WLAN baseband signals provided by the WLAN baseband processing circuitry 1108a and provide WLAN RF output signals to the FEM circuitry 1104a for subsequent wireless transmission by the one or more antennas 1101. BT radio IC circuitry 1106b may also include a transmit signal path which may include circuitry to up-convert BT baseband signals provided by the BT baseband processing circuitry 1108b and provide BT RF output signals to the FEM circuitry 1104b for subsequent wireless transmission by the one or more antennas 1101. In the embodiment of FIG. 11, although radio IC circuitries 1106a and 1106b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1108a-b may include a WLAN baseband processing circuitry 1108a and a BT baseband processing circuitry 1108b. The WLAN baseband processing circuitry 1108a may include a memory, such as, for example, a set of RAM arrays in a Fast Fourier Transform or Inverse Fast Fourier Transform block (not shown) of the WLAN baseband processing circuitry 1108a. Each of the WLAN baseband circuitry 1108a and the BT baseband circuitry 1108b may further include one or more processors and control logic to process the signals received from the corresponding WLAN or BT receive signal path of the radio IC circuitry 1106a-b, and to also generate corresponding WLAN or BT baseband signals for the transmit signal path of the radio IC circuitry 1106a-b. Each of the baseband processing circuitries 1108a and 1108b may further include physical layer (PHY) and medium access control layer (MAC) circuitry, and may further interface with a device for generation and processing of the baseband signals and for controlling operations of the radio IC circuitry 1106a-b.

Referring still to FIG. 11, according to the shown embodiment, WLAN-BT coexistence circuitry 1113 may include logic providing an interface between the WLAN baseband circuitry 1108a and the BT baseband circuitry 1108b to enable use cases requiring WLAN and BT coexistence. In addition, a switch 1103 may be provided between the WLAN FEM circuitry 1204a and the BT FEM circuitry 1104b to allow switching between the WLAN and BT radios according to application needs. In addition, although the antennas 1101 are depicted as being respectively connected to the WLAN FEM circuitry 1104a and the BT FEM circuitry 1104b, embodiments include within their scope the sharing of one or more antennas as between the WLAN and BT FEMs, or the provision of more than one antenna connected to each of FEM 1104a or 1104b.

In some embodiments, the front-end module circuitry 1104a-b, the radio IC circuitry 1106a-b, and baseband processing circuitry 1108a-b may be provided on a single radio card, such as wireless radio card 1102. In some other embodiments, the one or more antennas 1201, the FEM circuitry 1104a-b and the radio IC circuitry 1106a-b may be provided on a single radio card. In some other embodiments, the radio IC circuitry 1106a-b and the baseband processing circuitry 1108a-b may be provided on a single chip or integrated circuit (IC), such as IC 1112.

In some embodiments, the wireless radio card 1102 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11 ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 11, the BT baseband circuitry 1108b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

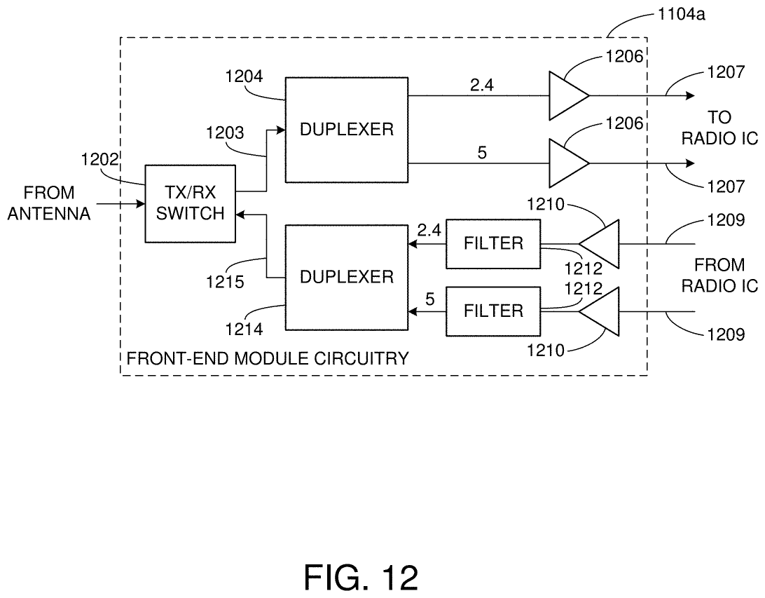

FIG. 12 illustrates WLAN FEM circuitry 1104a in accordance with some embodiments. Although the example of FIG. 12 is described in conjunction with the WLAN FEM circuitry 1104a, the example of FIG. 12 may be described in conjunction with the example BT FEM circuitry 1104b (FIG. 11), although other circuitry configurations may also be suitable.

In some embodiments, the FEM circuitry 1104a may include a TX/RX switch 1202 to switch between transmit mode and receive mode operation. The FEM circuitry 1104a may include a receive signal path and a transmit signal path. The receive signal path of the FEM circuitry 1104a may include a low-noise amplifier (LNA) 1206 to amplify received RF signals 1203 and provide the amplified received RF signals 1207 as an output (e.g., to the radio IC circuitry 1106a-b (FIG. 11)). The transmit signal path of the circuitry 1104a may include a power amplifier (PA) to amplify input RF signals 1209 (e.g., provided by the radio IC circuitry 1106a-b), and one or more filters 1212, such as band-pass filters (BPFs), low-pass filters (LPFs) or other types of filters, to generate RF signals 1315 for subsequent transmission (e.g., by one or more of the antennas 1101 (FIG. 11)) via an example duplexer 1214.

In some dual-mode embodiments for Wi-Fi communication, the FEM circuitry 1104a may be configured to operate in either the 2.4 GHz frequency spectrum or the 5 GHz frequency spectrum. In these embodiments, the receive signal path of the FEM circuitry 1104a may include a receive signal path duplexer 1204 to separate the signals from each spectrum as well as provide a separate LNA 1206 for each spectrum as shown. In these embodiments, the transmit signal path of the FEM circuitry 1104a may also include a power amplifier 1210 and a filter 1212, such as a BPF, an LPF or another type of filter for each frequency spectrum and a transmit signal path duplexer 1204 to provide the signals of one of the different spectrums onto a single transmit path for subsequent transmission by the one or more of the antennas 1101 (FIG. 11). In some embodiments, BT communications may utilize the 2.4 GHz signal paths and may utilize the same FEM circuitry 1104a as the one used for WLAN communications.

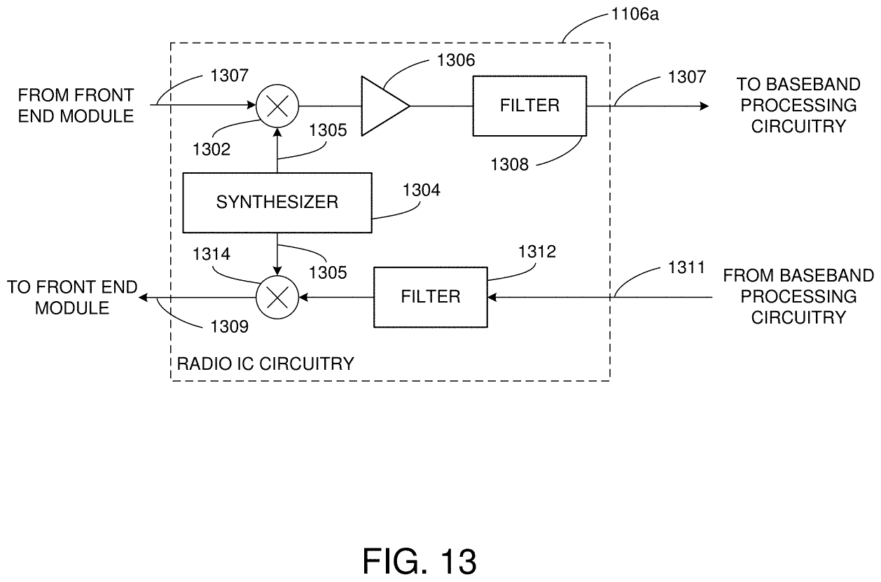

FIG. 13 illustrates radio IC circuitry 1106a in accordance with some embodiments. The radio IC circuitry 1106a is one example of circuitry that may be suitable for use as the WLAN or BT radio IC circuitry 1106a/1106b (FIG. 11), although other circuitry configurations may also be suitable. Alternatively, the example of FIG. 13 may be described in conjunction with the example BT radio IC circuitry 1106b.

In some embodiments, the radio IC circuitry 1106a may include a receive signal path and a transmit signal path. The receive signal path of the radio IC circuitry 1106a may include at least mixer circuitry 1302, such as, for example, down-conversion mixer circuitry, amplifier circuitry 1306 and filter circuitry 1308. The transmit signal path of the radio IC circuitry 1106a may include at least filter circuitry 1312 and mixer circuitry 1314, such as, for example, upconversion mixer circuitry. Radio IC circuitry 1106a may also include synthesizer circuitry 1304 for synthesizing a frequency 1305 for use by the mixer circuitry 1302 and the mixer circuitry 1314. The mixer circuitry 1302 and/or 1314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 13 illustrates only a simplified version of a radio IC circuitry, and may include, although not shown, embodiments where each of the depicted circuitries may include more than one component. For instance, mixer circuitry 1414 may each include one or more mixers, and filter circuitries 1308 and/or 1312 may each include one or more filters, such as one or more BPFs and/or LPFs according to application needs. For example, when mixer circuitries are of the direct-conversion type, they may each include two or more mixers.

In some embodiments, mixer circuitry 1302 may be configured to down-convert RF signals 1207 received from the FEM circuitry 1104a-b (FIG. 11) based on the synthesized frequency 1305 provided by synthesizer circuitry 1304. The amplifier circuitry 1306 may be configured to amplify the down-converted signals and the filter circuitry 1308 may include an LPF configured to remove unwanted signals from the down-converted signals to generate output baseband signals 1307. Output baseband signals 1307 may be provided to the baseband processing circuitry 1108a-b (FIG. 11) for further processing. In some embodiments, the output baseband signals 1307 may be zero-frequency baseband signals, although this is not a requirement. In some embodiments, mixer circuitry 1302 may comprise passive mixers, although the scope of the embodiments is not limited in this respect.

In some embodiments, the mixer circuitry 1314 may be configured to up-convert input baseband signals 1311 based on the synthesized frequency 1305 provided by the synthesizer circuitry 1304 to generate RF output signals 1209 for the FEM circuitry 1104a-b. The baseband signals 1311 may be provided by the baseband processing circuitry 1108a-b and may be filtered by filter circuitry 1312. The filter circuitry 1312 may include an LPF or a BPF, although the scope of the embodiments is not limited in this respect.

In some embodiments, the mixer circuitry 1302 and the mixer circuitry 1314 may each include two or more mixers and may be arranged for quadrature down-conversion and/or upconversion respectively with the help of synthesizer 1304. In some embodiments, the mixer circuitry 1302 and the mixer circuitry 1314 may each include two or more mixers each configured for image rejection (e.g., Hartley image rejection). In some embodiments, the mixer circuitry 1302 and the mixer circuitry 1314 may be arranged for direct down-conversion and/or direct upconversion, respectively. In some embodiments, the mixer circuitry 1302 and the mixer circuitry 1414 may be configured for super-heterodyne operation, although this is not a requirement.

Mixer circuitry 1302 may comprise, according to one embodiment: quadrature passive mixers (e.g., for the in-phase (I) and quadrature phase (Q) paths). In such an embodiment, RF input signal 1207 from FIG. 13 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1305 of synthesizer 1304 (FIG. 13). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1207 (FIG. 12) may comprise a balanced signal, although the scope of the embodiments is not limited in this respect. The I and Q baseband output signals may be provided to low-noise amplifier, such as amplifier circuitry 1306 (FIG. 13) or to filter circuitry 1308 (FIG. 13).

In some embodiments, the output baseband signals 1307 and the input baseband signals 1311 may be analog baseband signals, although the scope of the embodiments is not limited in this respect. In some alternate embodiments, the output baseband signals 1307 and the input baseband signals 1311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1304 may be a fractional-N synthesizer or a fractional N/N+1 synthesizer, although the scope of the embodiments is not limited in this respect as other types of frequency synthesizers may be suitable. For example, synthesizer circuitry 1304 may be a delta-sigma synthesizer, a frequency multiplier, or a synthesizer comprising a phase-locked loop with a frequency divider. According to some embodiments, the synthesizer circuitry 1304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1304 may be provided by a voltage controlled oscillator (VCO), although that is not a requirement. A divider control input may further be provided by either the baseband processing circuitry 1108a-b (FIG. 11) depending on the desired output frequency 1305. In some embodiments, a divider control input (e.g., N) may be determined from a look-up table (e.g., within a Wi-Fi card) based on a channel number and a channel center frequency as determined or indicated by the example application processor 1110. The application processor 1110 may include, or otherwise be connected to, one of the example secure signal converter 101 or the example received signal converter 103 (e.g., depending on which device the example radio architecture is implemented in).

In some embodiments, synthesizer circuitry 1304 may be configured to generate a carrier frequency as the output frequency 1305, while in other embodiments, the output frequency 1305 may be a fraction of the carrier frequency (e.g., one-half the carrier frequency, one-third the carrier frequency). In some embodiments, the output frequency 1305 may be a LO frequency (fLO).

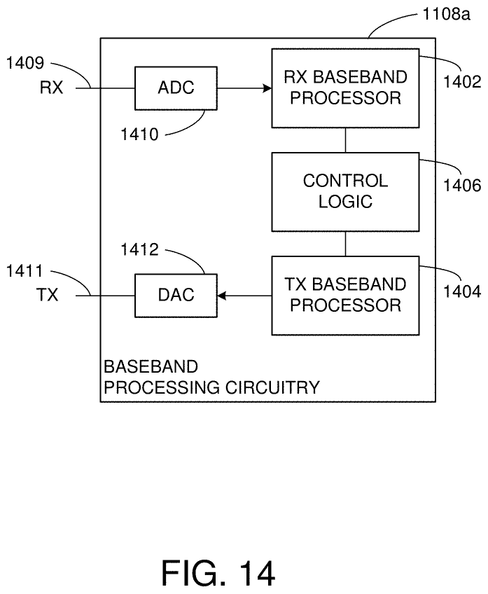

FIG. 14 illustrates a functional block diagram of baseband processing circuitry 1108a in accordance with some embodiments. The baseband processing circuitry 1108a is one example of circuitry that may be suitable for use as the baseband processing circuitry 1108a (FIG. 11), although other circuitry configurations may also be suitable. Alternatively, the example of FIG. 13 may be used to implement the example BT baseband processing circuitry 1108b of FIG. 11.

The baseband processing circuitry 1108a may include a receive baseband processor (RX BBP) 1402 for processing receive baseband signals 1309 provided by the radio IC circuitry 1106a-b (FIG. 11) and a transmit baseband processor (TX BBP) 1404 for generating transmit baseband signals 1311 for the radio IC circuitry 1106a-b. The baseband processing circuitry 1108a may also include control logic 1406 for coordinating the operations of the baseband processing circuitry 1108a.

In some embodiments (e.g., when analog baseband signals are exchanged between the baseband processing circuitry 1108a-b and the radio IC circuitry 1106a-b), the baseband processing circuitry 1108a may include ADC 1410 to convert analog baseband signals 1409 received from the radio IC circuitry 1106a-b to digital baseband signals for processing by the RX BBP 1402. In these embodiments, the baseband processing circuitry 1108a may also include DAC 1412 to convert digital baseband signals from the TX BBP 1404 to analog baseband signals 1411.

In some embodiments that communicate OFDM signals or OFDMA signals, such as through baseband processor 1108a, the transmit baseband processor 1404 may be configured to generate OFDM or OFDMA signals as appropriate for transmission by performing an inverse fast Fourier transform (IFFT). The receive baseband processor 1402 may be configured to process received OFDM signals or OFDMA signals by performing an FFT. In some embodiments, the receive baseband processor 1402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 11, in some embodiments, the antennas 1101 (FIG. 11) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1101 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may be a device having an apparatus comprising memory and processing circuitry configured to: identify a frame received, using a cellular stack, from a second device, the frame indicative of fifth-generation (5G) quality-of-service (QoS) characteristics; determine an Internet Protocol Security (IPSec) Security Parameter Index (SPI) field for IPSec association, the IPSec SPI field comprising a first value for an IPSec child security association or a second value for a signaling IPSec association established between the second device and the device; generate, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address; send the request frame to an access point device; and identify a response frame received, from the access point device, using the WLAN STA, the response frame indicative of an admission or rejection of the requested 802.11 User Priority.

Example 2 may include the apparatus of example 1 and/or some other example herein, wherein the request frame is an add traffic stream (ADDTS) frame.

Example 3 may include the apparatus of example 2 and/or some other example herein, wherein the request frame is sent during a multi-access protocol data unit (MA-PDU) session establishment.

Example 4 may include the apparatus of example 2 and/or some other example herein, wherein the request frame is sent during a device registration process.

Example 5 may include the apparatus of example 1 and/or some other example herein, wherein the request frame is a QoS Negotiation Request frame.

Example 6 may include the apparatus of example 5 and/or some other example herein, wherein the request frame is sent during a multi-access protocol data unit (MA-PDU) session establishment.

Example 7 may include the apparatus of example 5 and/or some other example herein, wherein the request frame is sent during a device registration process.

Example 8 may include the apparatus of example 1 and/or some other example herein, wherein the request frame further comprises a Traffic Specification (TSPEC) element indicative of parameters based on the 5G QoS characteristics, the TSPEC element comprising an indication of the requested User Priority

Example 8 may include the apparatus of example 1 and/or some other example herein, further comprising a transceiver configured to transmit and receive wireless signals comprising at least one of the beacon or the data frame.

Example 9 may include the apparatus of example 1 and/or some other example herein, wherein the processing circuitry is further configured to generate a mapping between TSPEC parameters and 5G QoS parameters.

Example 10 may include the apparatus of example 1 and/or some other example herein, wherein the request frame further comprises a 5G TSPEC element, wherein the 5G TSPEC element comprises the 5G QoS characteristics.

Example 11 may include the device of example 8 and/or some other example herein, further comprising an antenna coupled to the transceiver to cause to transmit and receive wireless signals including at least one of the frame, the request frame, or the response frame.

Example 12 may include the device of example 1 and/or some other example herein, further comprising an antenna coupled to the transceiver to cause to send the wireless signals.

Example 13 may include a non-transitory computer-readable medium storing computer-executable instructions which when executed by one or more processors result in performing operations comprising: identifying a frame received, using a cellular stack of an apparatus of a first device, from a second device, the frame indicative of fifth-generation (5G) quality-of-service (QoS) characteristics; determining an Internet Protocol Security (IPSec) Security Parameter Index (SPI) field for IPSec association, the IPSec SPI field comprising a first value for an IPSec child security association or a second value for a signaling IPSec association established between the second device and the device; generating, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address; sending the request frame to an access point device; and identifying a response frame received, from the access point device, using the WLAN STA, the response frame indicative of an admission or rejection of the requested 802.11 User Priority.

Example 14 may include the non-transitory computer-readable medium of example 13 and/or some other example herein, wherein the request frame is an add traffic stream (ADDTS) frame.

Example 15 may include the non-transitory computer-readable medium of example 13 and/or some other example herein, wherein the request frame is a QoS Negotiation Request frame.

Example 16 may include the non-transitory computer-readable medium of example 13 and/or some other example herein, wherein the request frame further comprises a Traffic Specification (TSPEC) element indicative of parameters based on the 5G QoS characteristics, the TSPEC element comprising an indication of the requested User Priority.

Example 17 may include a method comprising: identifying, by processing circuitry of an apparatus of a first device, a frame received, using a cellular stack, from a second device, the frame indicative of fifth-generation (5G) quality-of-service (QoS) characteristics; determining, by the processing circuitry, an Internet Protocol Security (IPSec) Security Parameter Index (SPI) field for IPSec association, the IPSec SPI field comprising a first value for an IPSec child security association or a second value for a signaling IPSec association established between the second device and the device; generating, by the processing circuitry, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address; sending, by the processing circuitry, the request frame to an access point device; and identifying by the processing circuitry, a response frame received, from the access point device, using the WLAN STA, the response frame indicative of an admission or rejection of the requested 802.11 User Priority.

Example 18 may include the method of example 17 and/or some other example herein, wherein the request frame is an add traffic stream (ADDTS) frame.

Example 19 may include the method of example 17 and/or some other example herein, wherein the request frame is a QoS Negotiation Request frame.

Example, 20 may include the method of example 17 and/or some other example herein, wherein the request frame further comprises a Traffic Specification (TSPEC) element indicative of parameters based on the 5G QoS characteristics, the TSPEC element comprising an indication of the requested User Priority.

Example 21 may include an apparatus comprising means for: identifying a frame received, using a cellular stack, from a second device, the frame indicative of fifth-generation (5G) quality-of-service (QoS) characteristics; determining an Internet Protocol Security (IPSec) Security Parameter Index (SPI) field for IPSec association, the IPSec SPI field comprising a first value for an IPSec child security association or a second value for a signaling IPSec association established between the second device and the device; generating, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address; sending the request frame to an access point device; and identifying a response frame received, from the access point device, using the WLAN STA, the response frame indicative of an admission or rejection of the requested 802.11 User Priority.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus of a device, the apparatus comprising:
processing circuitry; and
memory coupled to the processing circuitry, the processing circuitry configured to:
identify a frame received, using a cellular stack, from a second device, the frame indicative of fifth-generation (5G) quality-of-service (QoS) characteristics;
determine an Internet Protocol Security (IPSec) Security Parameter Index (SPI) field for IPSec association, the IPSec SPI field comprising a first value for an IPSec child security association or a second value for a signaling IPSec association established between the second device and the device;
generate, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address;
send the request frame to an access point device; and
identify a response frame received, from the access point device, using the WLAN STA, the response frame indicative of an admission or rejection of the requested 802.11 User Priority.

2. The apparatus of claim 1, wherein the request frame is an add traffic stream (ADDTS) frame.

3. The apparatus of claim 2, wherein the request frame is sent during a multi-access protocol data unit (MA-PDU) session establishment.

4. The apparatus of claim 2, wherein the request frame is sent during a device registration process.

5. The apparatus of claim 1, wherein the request frame is a QoS Negotiation Request frame.

6. The apparatus of claim 5, wherein the request frame is sent during a multi-access protocol data unit (MA-PDU) session establishment.

7. The apparatus of claim 5, wherein the request frame is sent during a device registration process.

8. The apparatus of claim 1, wherein the request frame further comprises a Traffic Specification (TSPEC) element indicative of parameters based on the 5G QoS characteristics, the TSPEC element comprising an indication of the requested User Priority.

9. The apparatus of claim 1, wherein the processing circuitry is further configured to generate a mapping between TSPEC parameters and 5G QoS parameters.

10. The apparatus of claim 1, wherein the request frame further comprises a 5G TSPEC element, wherein the 5G TSPEC element comprises the 5G QoS characteristics.

11. The apparatus of claim 1, further comprising a transceiver configured to transmit and receive wireless signals comprising at least one of the frame, the request frame, or the response frame.

12. The device of claim 11, further comprising an antenna coupled to the transceiver to cause to send the wireless signals.

13. A non-transitory computer-readable medium storing computer-executable instructions which when executed by one or more processors result in performing operations comprising:
identifying a frame received, using a cellular stack of an apparatus of a first device, from a second device, the frame indicative of fifth-generation (5G) quality-of-service (QoS) characteristics;
determining an Internet Protocol Security (IPSec) Security Parameter Index (SPI) field for IPSec association, the IPSec SPI field comprising a first value for an IPSec child security association or a second value for a signaling IPSec association established between the second device and the device;
generating, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address;
sending the request frame to an access point device; and
identifying a response frame received, from the access point device, using the WLAN STA, the response frame indicative of an admission or rejection of the requested 802.11 User Priority.

14. The non-transitory computer-readable medium of claim 13, wherein the request frame is an add traffic stream (ADDTS) frame.

15. The non-transitory computer-readable medium of claim 13, wherein the request frame is a QoS Negotiation Request frame.

16. The non-transitory computer-readable medium of claim 13, wherein the request frame further comprises a Traffic Specification (TSPEC) element indicative of parameters based on the 5G QoS characteristics, the TSPEC element comprising an indication of the requested User Priority.

17. A method, comprising:
identifying, by processing circuitry of an apparatus of a first device, a frame received, using a cellular stack, from a second device, the frame indicative of fifth-generation (5G) quality-of-service (QoS) characteristics;
determining, by the processing circuitry, an Internet Protocol Security (IPSec) Security Parameter Index (SPI) field for IPSec association, the IPSec SPI field comprising a first value for an IPSec child security association or a second value for a signaling IPSec association established between the second device and the device;
generating, by the processing circuitry, using a wireless local area network station (WLAN STA) of the device, a request frame, the request frame comprising a requested 802.11 User Priority, and comprising an IPSec information element, the IPSec information element comprising an IPSec Security Protocol field indicative of an encapsulated security protocol, the IPSec information element further comprising the IPSec SPI field and a destination Internet Protocol (IP) address;
sending, by the processing circuitry, the request frame to an access point device; and
identifying, by the processing circuitry, a response frame received, from the access point device, using the WLAN STA, the response frame indicative of an admission or rejection of the requested 802.11 User Priority.

18. The method of claim 17, wherein the request frame is an add traffic stream (ADDTS) frame.

19. The method of claim 17, wherein the request frame is a QoS Negotiation Request frame.

20. The method of claim 17, wherein the request frame further comprises a Traffic Specification (TSPEC) element indicative of parameters based on the 5G QoS characteristics, the TSPEC element comprising an indication of the requested User Priority.
